(19) United States
(12) Patent Application Publication
(10) Pub. No.: US 2008/0072780 A1
(43) Pub. Date: Mar. 27, 2008

(54) LITHOGRAPHIC PRINTING PLATE PRECURSOR AND METHOD FOR PREPARATION THEREOF

(75) Inventors: Koji Sonokawa, Shizuoka (JP); Katsumi Araki, Shizuoka (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 11/862,638

(22) Filed: Sep. 27, 2007

(30) Foreign Application Priority Data
Sep. 27, 2006 (JP) 2006-263212

(51) Int. Cl. B41N 3/00

(52) U.S. Cl. 101/467

(57) ABSTRACT

A lithographic printing plate precursor includes: a support; an image-recording layer capable of being removed with water or an aqueous component; and an overcoat layer, in this order, wherein the overcoat layer is formed by drying a water-dispersible polymer particle, or includes: a support; an image-recording layer which is capable of being removed with at least one of printing ink and dampening water and contains (A) an infrared absorbing agent, (B) a polymerization initiator and (C) a polymerizable compound; and an overcoat layer, in this order, wherein the overcoat layer is formed by drying a water-dispersible polymer particle.

### FIELD OF THE INVENTION

The present invention relates to a lithographic printing plate precursor and a method for preparation thereof. More specifically, it relates to a lithographic printing plate precursor capable of undergoing a so-called direct plate-making, which can be directly plate-made by scanning of an infrared laser based on digital signals, for example, from a computer and a method for preparation thereof.

### BACKGROUND OF THE INVENTION

In general, a lithographic printing plate is composed of an oleophilic image area accepting ink and a hydrophilic non-image area accepting dampening water in the process of printing. Lithographic printing is a printing method utilizing the nature of water and oily ink to repel with each other and comprising rendering the oleophilic image area of the lithographic printing plate to an ink-receptive area and the hydrophilic non-image area thereof to a dampening water-receptive area (ink-unreceptive area), hereby making a difference in adherence of the ink on the surface of the lithographic printing plate, depositing the ink only to the image area, and then transferring the ink to a printing material, for example, paper.

In order to produce the lithographic printing plate, a lithographic printing plate precursor (PS plate) comprising a hydrophilic support having provided thereon an oleophilic photosensitive resin layer (image-recording layer) has heretofore been broadly used. Ordinarily, the lithographic printing plate is obtained by conducting plate-making according to a method of exposing the lithographic printing plate precursor through an original, for example, a lith film, and then while leaving the part forming the image area of the image-recording layer, removing the other unnecessary image-recording layer by dissolving with an alkaline developer or an organic solvent to reveal the hydrophilic surface of support to form the non-image area.

In the hitherto known plate-making process of lithogaphic printing plate precursor, after exposure, the step of removing the unnecessary image-recording layer by dissolving, for example, with a developer is required. However, it is one of the subjects to save or simplify such an additional wet treatment described above. Particularly, since disposal of liquid wastes discharged resulting from the wet treatment has become a great concern throughout the field of industry in view of the consideration for global environment in recent years, the demand for the solution of the above-described subject has been increased more and more.

As one of simple plate-making methods in response to the above-described requirement, a method referred to as on-machine development has been proposed wherein a lithographic printing plate precursor having an image-recording layer capable of being removed in the unnecessary areas during a conventional printing process is used and after exposure, the unnecessary area of the image-recording layer is removed on a printing machine to prepare a lithographic printing plate.

Specific methods of the on-machine development include, for example, a method of using a lithographic printing plate precursor having an image-recording layer that can be dissolved or dispersed in dampening water, an ink solvent or an emulsion of dampening water and ink, a method of mechanically removing an image-recording layer by contact with rollers or a blanket cylinder of a printing machine, and a method of lowering cohesion of an image-recording layer or adhesion between an image-recording layer and a support upon penetration of dampening water, ink solvent or the like and then mechanically removing the image-recording layer by contact with rollers or a blanket cylinder of a printing machine.

In the invention, unless otherwise indicated particularly, the term “development processing step” means a step of using an apparatus (ordinarily, an automatic developing machine) other than a printing machine and removing an unexposed area to infrared laser in an image-recording layer of a lithographic printing plate precursor upon contact with liquid (ordinarily, an alkaline developer) thereby revealing a hydrophilic surface of support. The term “on-machine development” means a method or a step of removing an unexposed area in an image-recording layer of a lithographic printing plate precursor upon contact with liquid (ordinarily, printing ink and/or dampening water) by using a printing machine thereby revealing a hydrophilic surface of support.

However, in the case of using a conventional image-recording layer for the image-recording system utilizing an ultraviolet ray or visible light, a troublesome method must be taken such that the exposed lithographic printing plate precursor is preserved under a completely light-shielded state or under a constant temperature condition during the period of time until it is loaded on a printing machine because the image-recording layer is not fixed after the image exposure.

On the other hand, digitalized technique of electronically processing, accumulating and outputting image information using a computer has been popularized in recent years, and various new image-outputting systems responding to the digitalized technique have been put into practical use. Correspondingly, attention has been drawn to a computer-to-plate technique of carrying digital image information on highly converging radiation, for example, a laser beam and conducting scanning exposure of a lithographic printing plate precursor with the radiation thereby directly preparing a lithographic printing plate without using a lith film. Thus, it is one of the important technical subjects to obtain a lithographic printing plate precursor adaptable to the technique described above.

As described above, in recent years, the simplification of plate-making operation and the realization of dry system and non-processing system have been further strongly required from both aspects of the consideration for global environment and the adaptation for digitization.

Recently, high-power laser, for example, a semiconductor laser or YAG laser can be inexpensively available. Thus, it is expected to use such a high-power laser as an image-recording means in the production of a lithographic printing plate including scanning exposure which is easy to be incorporated into the digitalized technique.

In conventional plate-making methods, image-recording is conducted by imagewise exposure of a photosensitive lithographic printing plate precursor in low-light intensity to middle-light intensity to cause the imagewise change of physical properties due to the photochemical reaction. On the contrary, in the exposure method of using a high-power laser, the exposure region is irradiated with a large quantity of light energy in an extremely short period of time, the light energy is efficiently converted to heat energy to cause a chemical change, a phase change or a thermal change, for example, change of form or structure in the image-recording layer, and the change is utilized in the image recording. Specifically, although the image data are inputted by light energy, for example, laser light, the image-recording is performed in the state where the ion due to the heat energy is added to the light energy. The recording system utilizing heat generation by such high-power density exposure is ordinarily referred to as heat-mode recording and the conversion of light energy to heat energy is referred to as light-to-heat conversion.

The great advantages of plate-making method using the heat-mode recording reside in that the image-recording layer does not sensitize with light of ordinary light intensity level, for example, room illumination and in that the image recorded by exposure of high-light intensity do not necessitate fixing. Specifically, the lithographic printing plate precursor for use in the heat-mode recording is in no danger of sensitization to room light before image exposure and fixing of the image after the image exposure is not essential. Therefore, for example, when an image-recording layer table of being insolubilized or solubilized by exposure using the high-power laser is used and a plate-making process of making the exposed image-recording layer imagewise to prepare a lithographic printing plate is conducted by on-machine development, it becomes possible to realize a printing system in which the image is not affected even when the lithographic printing plate precursor is exposed to environment light in a room after the image exposure. Accordingly, by utilizing the heat-mode recording, it is expected that it will be possible to obtain a lithographic printing plate precursor which is suitable for the on-machine development.

Recent development of lasers is significant and a semiconductor laser or solid laser having high-power and a small size and emitting an infrared ray having a wavelength of 760 to 1,200 is easily available. Such an infrared laser is extremely useful for a recording light source for conducting plate-making based on digital data, for example, from a computer.

As the lithographic printing plate precursor of on-machine development type capable of undergoing image-recording with an infrared laser, for example, a lithographic printing plate precursor having provided on a hydrophilic support, an image-forming layer in which hydrophobic thermoplastic polymer particles are dispersed in a hydrophilic binder is described in Japanese Patent 2,939,397 (corresponding to EP0770494A2). It is described in Japanese Patent 2,938,397 (corresponding to EP0770494A2) that the lithographic printing plate precursor is exposed to an infrared laser to agglomerate the hydrophobic thermoplastic polymer particles by heat thereby forming an image, and mounted on a plate cylinder of a printing machine to be able to carry out on-machine development by supplying dampening water and/or ink.

Although the method of forming image by the agglomeration of fine particles only upon thermal fusion shows good on-machine development property, it has a problem in that the image strength (adhesion property to the support) is extremely weak and printing durability is insufficient.

Further, lithographic printing plate precursors having provided on a hydrophilic support, microcapsules containing a polymerizable compound encapsulated therein are described in JP-A-2001-277740 (the term “JP-A” as used herein means an “unexamined published Japanese patent application”) and JP-A-2001-277742.

Moreover, a lithographic printing plate precursor having provided on a support, a photosensitive layer containing an infrared absorbing agent, a radical polymerization initiator and a polymerizable compound is described in JP-A-2002-287334 (corresponding to US2002/0177074A1).

The methods using the polymerization reaction have a feature that since the chemical bond density in the image area is high, the image strength is relatively good in comparison with the image area formed by the thermal fusion of fine polymer particles. However, it is necessary to provide an oxygen blocking overcoat layer on the photosensitive layer in order to prevent polymerization inhibition due to oxygen in the atmosphere and back surface adhesion due to tackiness of the polymerizable compound.

As the overcoat layer using for the purpose, it is ordinarily well known to use a water-soluble resin, for example, polyvinyl alcohol. A lithographic printing plate precursor of on-machine development type having an overcoat layer using a modified polyvinyl alcohol is described in JP-A-2005-271284. Further, a lithographic printing plate precursor having an overcoat layer of oxygen blocking function using mica together with a water-soluble resin is described in JP-A-2005-119273 (corresponding to US2005/0069811A1).

However, as for the lithographic printing plate precursor of on-machine development type, even when such an overcoat layer is provided, polymerization efficiency (sensitivity) and printing durability are still insufficient and in addition, an ink-receptive property degrades in some cases.

### SUMMARY OF THE INVENTION

Therefore, an object of the present invention is to provide a lithographic printing plate precursor which is capable of undergoing image recording with an infrared laser, can provide a large amount of good printed materials by a practical energy amount and exhibits good ink-receptive property, a method for the preparation of the lithographic printing plate precursor, and a lithogaphic printing method using the lithographic printing plate precursor.

As a result of the intensive investigations on constituting components for use in an overcoat layer of a lithographic printing plate precursor of on-machine development type, the inventor has found that the above-described object can be achieved by using an overcoat layer formed by applying (coating with) a water-dispersible polymer particle and drying the applied water-dispersible polymer particle to complete the invention. Specifically, the present invention includes the following items.

1. A lithographic printing plate precursor comprising a support, an image-recording layer capable of being removed with water or an aqueous component and an overcoat layer in this order, wherein the overcoat layer is a layer formed by applying water-dispersible polymer particle and drying the applied water-dispersible polymer particle.

2. A lithographic printing plate precursor comprising a support, an image-recording layer which is capable of being removed with printing ink, dampening water (fountain solution) or both of them and contains (A) an infrared absorbing agent, (B) a polymerization initiator and (C) a polymerizable compound and an overcoat layer in this order, wherein the overcoat layer is a layer formed by applying water-dispersible polymer particle and drying the applied water-dispersible polymer particle.

3. The lithographic printing plate precursor as described in 1. or 2. above, wherein an average particle size of the water-dispersible polymer particle is from 0.01 to 1 μm.

4. The lithographic printing plate precursor as described in any one of 1. to 3. above, wherein a polymer forming the water-dispersible polymer particle is a polymer having an amido group or a sulfonylamido group in its side chain.

5. The lithographic printing plate precursor as described in any on of 1. to 4. above, wherein the image-recording layer further contains (D) fine polymer particle having a polymerizable reactive group.

6. The lithographic printing plate precursor as described in any on of 1. to 5. above which further comprises undercoat layer comprising a compound having a polymerizable reactive group between the support and the image-recording layer.

7. A method for preparation of a lithographic printing plate precursor comprising a support, an image-recording layer which is capable of being removed with printing ink, dampening water or both of them and contains (A) an infrared absorbing agent, (B) a polymerization initiator and (C) a polymerizable compound and an overcoat layer in this order, wherein the overcoat layer is formed by applying water-dispersible polymer particle and drying the applied water-dispersible polymer particle.

According to the preset invention, a lithographic printing plate precursor which is capable of undergoing image recording with a laser emitting an infrared ray, can provide a large amount of good printed materials by a practical energy amount and exhibits good ink-receptive properly, a method for the preparation of the lithographic printing plate precursor, and a lithographic printing method using the lithographic printing plate precursor can be provided.

### DETAILED DESCRIPTION OF THE INVENTION

The present invention will be described in more detail below.

### [Overcoat Layer]

The lithographic printing plate precursor according to the invention is characterized by having an overcoat layer formed by applying water-dispersible polymer particle and drying the applied water-dispersible polymer particle on an image-recording layer which is capable of being removed with printing ink, dampening water or both of them and contains (A) an infrared absorbing agent, (B) a polymerization initiator and (C) a polymerizable compound.

The water-dispersible polymer particle for use in the invention is described below.

The water-dispersible polymer particle for use in the invention means a polymer particle as a dispersoid heterogeneously dispersed in water as a dispersion medium and configuration of the aqueous dispersion solution thereof is ordinarily referred to as an emulsion which comprises water as a continuous phase and a spherical polymer particle as a discontinuous phase and has translucent or opaque, white or similar color in appearance.

The emulsion is classified into (1) to (3) shown below according to the production method thereof and the product according to any production method can be used in the invention.

### (1) Natural Latex

This indicates an emulsion of a polymer naturally occurred and is essentially the origin of the latex. Most of the emulsions belonging to this class are natural rubber latexes.

### (2) Synthetic Latex

This means a synthetic latex in a narrow sense and indicates an emulsion of synthetic polymer produced by emulsion polymerization. Representative examples of the synthetic latex include styrene-butadiene rubber (SBR), acrylonitrile-butadiene rubber (NBR), chloroprene rubber (CR) and a polymer, for example, of acrylate, vinyl acetate or vinyl chloride.

The emulsion polymerization is a polymerization method as follows. Specifically, when a monomer is dispersed in an aqueous solution of an emulsifier, the monomer is solubilized in a micelle of the emulsifier and by adding a water-soluble initiator to the solution to generate a radical, a free radical is incorporated in to the micelle in which the radical reacts with the monomer to form a polymer, whereby a water-dispersible polymer particle is prepared.

### (3) Artificial Latex

This is classified in a synthetic latex in a broad sense in some cases, but is a latex prepared by artificially emulsified a bulk polymer of a natural polymer of synthetic polymer without conducting the emulsion polymerization, and is referred to as a dispersion. Representative examples of the artificial latex include natural rubber, isoprene rubber (IR), butadiene rubber (BR), isobutene-isoprene rubber (IIR) and a polymer, for example, polyurethane, polyethylene or polybutene.

The dispersion is prepared by dispersing in water a polymer obtained by a polymerization method other than the emulsion polymerization using an emulsifier in the following manner.
a) Natural rubber or the like is sufficiently softened by a roll or Banbury mixer, an emulsifier is kneaded therein, and then water is gradually added thereto to cause phase transition thereby forming a dispersion.
b) IIR, IR or the like is emulsified and dispersed as a solution thereof in water together with an emulsifier, and then the solvent is removed to obtain an emulsion.
c) Polymer which is liquid or becomes liquid by heating at 100° C. or below, for example, polyethylene or polybutene is emulsified in liquid form in water together with an emulsifier to from an emulsion.

As the kind of polymer for use in the water-dispersible polymer particle according to the invention, various polymers can be used other then the representative polymers of latexes described above. For example, an acrylic resin, a polyvinyl acetal resin, a polyurethane resin, a polyurea resin, a polyimide resin, a polyamide resin, an epoxy resin, a methacrylic resin, a polystyrene resin, a polyester resin, synthetic rubber and natural rubber are exemplified.

Among them, a polymer having in its side chain an amido group represented by formula (1) shown below or a sulfonylamido group represented by formula (2) shown below is preferable from the standpoint of the oxygen blocking property.

—CO—NR₁R₂ (1)

—CO-Z-SO₂NR₃R₄ (2)

In the formulae, R₁, R₂ and R₃ each represents a hydrogen atom, a substituted or unsubstituted alkyl group or an unsubstituted aryl group, R₄ represents a hydrogen atom, a substituted or unsubstituted aryl group, an unsubstituted aryl group or —SO₂R₅, R₅ represents a substituted or unsubstituted alkyl group or an unsubstituted aryl group, and Z represents a divalent connecting group.

The water-dispersible polymer particles for use in the invention are stabilized to prevent from aggregation due to attracting each other with van der Waals force, sedimentation due to gravity and flotation. This is mainly based on electric repulsion caused by the charge of the particle and physical barriers or steric effects due to substances adsorbed on the particle, for example, an emulsifier or a protective colloid.

The charge of water-dispersible polymer particle is ordinarily negative (−) and it is mainly based on ionization of the emulsifier, protective colloid or polymer particle per se and ions adsorbed. The repulsion between the particles caused by the charge is strong when a cation valency and ion concentration of the aqueous phase are low and functions to prevent the aggregation of particles. However, when a polyvalent cation is added, the aggregation may occur in some cases.

On the other hand, in the case of a so-called cationic emulsion positively charged, the situation is exactly opposite to that described above.

Further, a nonionic emulsion in which a polymer particle charged negatively or positively is used together with a nonionic surfactant or a nonionic water-soluble polymer, for example, polyvinyl alcohol is also usefully used in the invention.

According to the invention, a coating solution containing the water-dispersible polymer particle described above is applied according to a method described hereinafter and in a subsequent drying step the applied water-dispersible polymer particle is heated higher than the minimum film formation temperature of the polymer particle used to form a continuous film. The minimum film formation temperature is present close to the second-order transition point of the polymer but since film formation temperature at which the film exhibits sufficient strength is temperature at which the polymer sufficiently flows, the heating is performed at temperature much higher than the second-order transition point in many cases.

The process of the film formation is different from that of an ordinary polymer solution, and at first the space between polymer particles gradually narrows by evaporation of water to reach the most densely packed state and the fluidity is lost. This point is also referred to as a gelation point. As the further progress of drying, the water remaining in the space between the polymer particles evaporates and the space narrows by capillary pressure to accelerate fusion of the polymer particles each other finally to form a uniform film. On this occasion, when the polymer is difficult to transform the fusion is incomplete and cracks may occur by the entire volume stage due to the evaporation of water, resulting in a discontinuous film. In such a case, however, by previously adding, for example, a solvent for the polymer or a plasticizer, it is possible to soften the polymer thereby forming a continuous film.

The average part size of the water-dispersible polymer particle for use in the invention is preferably from 0.01 to 1 μm, and more preferably from 0.5 to 0.5 μm. When the average particle size is less than 0.01 μm, the effect for improvement in the printing durability lowers, whereas when it exceeds 1 μm, the dispersion stability of the polymer particles in the coating solution decreases and the on-machine development property tends to deteriorate.

As other components of the overcoat layer for use in the invention, known additives, for example, various water-soluble polymers, water-soluble plasticizers or surfactants, from the standpoint of increase in the stability of coating solution, increase in coating property and improvement in physical properties of the layer formed.

As the water-soluble polymer, for example, polyvinyl alcohol, a modified product thereof starch, processed starch, casein, glue, gum arabic, sodium alginate, pectin, carboxymethyl cellulose, methyl cellulose, viscose, polyacrylamide, polyethyleneimine, sodium polyacrylate, polyethylene dioxide or polyvinyl pyrrolidone is exemplified.

As the water-soluble plasticizer, for example, propionamide, cyclohexanediol, glycerol or sorbitol is exemplified.

As the surfactant, for example, an anionic surfactant for example, sodium alkylsulfate or sodium alkylsulfonate; an amphoteric surfactant, for example, alkylaminocarboxylate and alkylaminodicarboxylate; or a nonionic surfactant, for example, polyoxyethylene alkyl phenyl ether is exemplified.

Further, other functions can also be provided to the overcoat layer. For instance, by adding a coloring agent (for example, a water-soluble dye) which is excellent in permeability for light used for the exposure and capable of efficiently absorbing light at other wavelengths, a safe light adaptability can be improved without causing the decrease in sensitivity.

Moreover, known additives for improving adhesion property to the image-recording layer or preservation stability of the coating solution may be added.

The coating solution for overcoat layer thus-prepared is applied on the image-recording layer provided on the support and dried to form the overcoat layer. The solvent for coating is basically water and a small amount of an organic solvent, for example, methanol or ethanol may be added for the purposes of improvement in physical properties of the coating solution, improvement in coating property and improvement in adhesion property to the image-recording layer.

A coating method of the overcoat layer is not particularly limited, and known methods, for example, methods described in U.S. Pat. No. 3,458,311 and JP-B-55-49729 (the term “JP-B” as used herein means an “examined Japanese patent publication”) can be utilized. Specific examples of the coating method for the overcoat layer include a blade coating method, an air knife coating method, a gravure coating method, a roll coating method, a spray coating method, a dip coating method and a bar coating method.

The coating amount of the overcoat layer is preferably in a range of 0.01 to 10 g/m², more preferably in a range of 0.05 to 3 g/m², and most preferably in a range of 0.1 to 1 g/m², in terms of the coating amount after drying.

### [Image-Recording Layer]

The lithographic printing plate precursor according to the invention has an image-recording layer capable of being recorded with irradiation of infrared ray containing (A) an infrared absorbing agent, (B) a polymerization initiator and (C) a polymerizable compound. In the lithographic printing plate precursor, by the irradiation of infrared ray the exposed area of the image-recording layer is cured to form a hydrophobic (oleophilic) area and the unexposed area is promptly removed from the support with dampening water, ink or an emulsion of dampening water and ink. Specifically, the image-recording layer is an image-recording layer capable of being removed with printing ink and/or dampening water. Each of the constituting components of the image-recording layer will be described in detail below.

### <(A) Infrared Absorbing Agent>

In the case wherein the lithographic printing plate precursor according to the invention is subjected to the image formation using as a light source, a laser emitting an infrared ray of 760 to 1,200 nm, it is ordinarily essential to use an infrared absorbing agent. The infrared absorbing agent has a function of converting the infrared ray absorbed to heat and a function of being excited by the infrared ray to perform electron transfer/energy transfer to a polymerization initiator (radical generator) described hereinafter. The infrared absorbing agent for use in the invention includes a dye and pigment each having an absorption maximum in a wavelength range of 760 to 1,200 nm.

As the dye, commercially available dyes and known dyes described in literatures, for example, Senryo Binran (Dye Handbook) compiled by The Society of Synthetic Organic Chemistry, Japan (1970) can be used. Specifically, the dyes includes azo dyes, metal complex azo dyes, pyrazolone azo dyes, naphthoquinone dyes, anthraquinone dyes, phthalocyanine dyes, carbonium dyes, quinoneimine dyes, methine dyes, cyanine dyes, squarylium dyes, pyrylium salts and metal thiolate complexes.

Examples of preferable dye include cyanine dyes described, for example, in JP-A-58-125246, JP-A-59-84356 and JP-A-60-78787, methine dyes described, for example, in JP-A-58-173696, JP-A-58-181690 and JP-A-58-194595, naphthoquinone dyes described, for example, in JP-A-58-112793, JP-A-58-224793, JP-A-59-48187, JP-A-59-73996, JP-A-60-52940 and JP-A-60-63744, squarylium dyes described, for example, in JP-A-58-112792, and cyanine dyes described, for example, in British Patent 434,875.

Also, near infrared absorbing sensitizers described in U.S. Pat. No. 5,156,938 are preferably used. Further, substituted arylbenzo(thio)pyrylium salts described in U.S. Pat. No. 3,881,924, trimethinethiapyrylium salts described in JP-A-57-142645 (corresponding to U.S. Pat. No. 4,327,169), pyrylium compounds described in JP-A-58-181051, JP-A-58-220143, JP-A-59-41363, JP-A-59-84248, JP-A-59-84249, JP-A-59-146063 and JP-A-59-146061, cyanine dyes described in JP-A-59-216146, pentamethinethiopyrylium salts described in U.S. Pat. No. 4,283,475, and pyrylium compounds described in JP-B-5-13514 and JP-B-5-19702 are also preferably used. Other preferred examples of the dye include near infrared absorbing dyes represented by formulae (I) and (II) in U.S. Pat. No. 4,756,993.

Other preferable examples of the infrared absorbing dye according to the invention include specific indolenine cyanine dyes described in JP-A-2002-278057 as illustrated below.

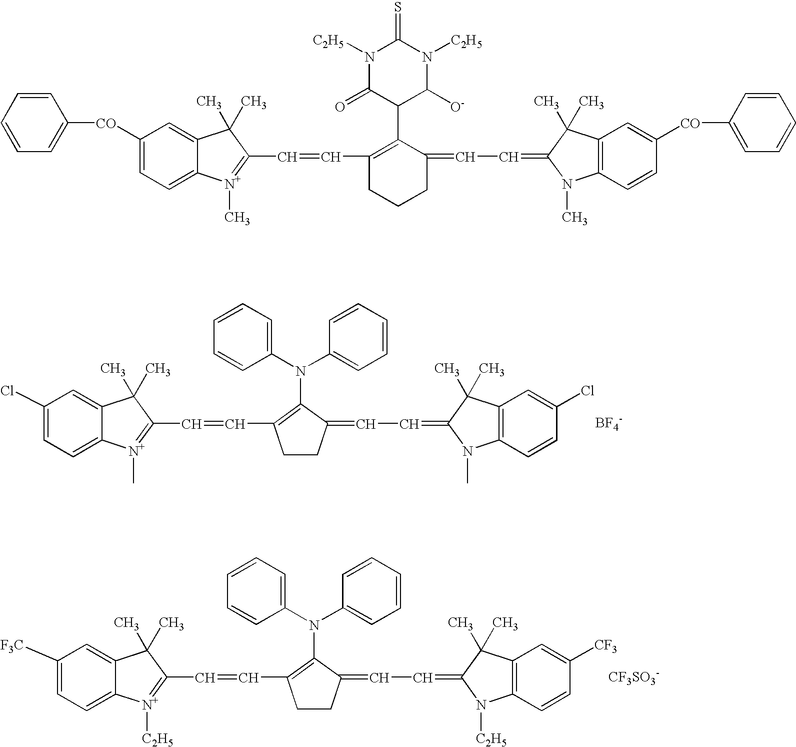

Of the dyes, cyanine dyes, squarylium dyes, pyrylium dyes, nickel thiolate complexes and indolenine cyanine dyes are particularly preferred. Further cyanine dyes and indolenine cyanine dyes are more preferred. As a particularly perferable example of the dye, a cyanine dye represented by the following formula (i) is exemplified.

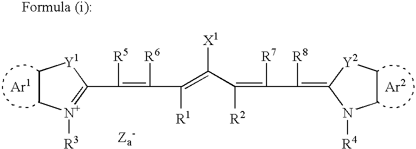

In formula (i), X¹ represents a hydrogen atom, a halogen atom, —NPh₂, X²-L¹ or a group shown below. X² represents an oxygen atom, a nitrogen atom or a sulfur atom, L¹ represents a hydrocarbon group having from 1 to 12 carbon atoms, an aromatic ring containing a hetero atom or a hydrocarbon group having from 1 to 12 carbon atoms and containing a hetero atom. The hetero atom indicates here a nitrogen atom, a sulfur atom, an oxygen atom, a halogen atom or a selenium atom. Xa⁻ has the same meaning as Za⁻ defined hereinafter. R^{a} represents a substituent selected from a hydrogen atom, an alkyl group, an aryl group, a substituted or unsubstituted amino group and a halogen atom.

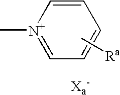

R¹ and R² each independently represents a hydrocarbon group having from 1 to 12 carbon atoms. In view of the preservation stability of a coating solution for image-recording layer, it is preferred that R¹ and R² each represents a hydrocarbon group having two or more carbon atoms, and it is particularly preferred that R¹ and R² are combined with each other to form a 5-membered or 6-membered ring.

Ar¹ and Ar², which may be the same or different, each represents an aromatic hydrocarbon group which may have a substituent. Preferable examples of the aromatic hydrocarbon group include a benzene ring and a naphthalene ring. Also, preferable examples of the substituent include a hydrocarbon group having 12 or less carbon atoms, a halogen atom and an alkoxy group having 12 or less carbon atoms, and a hydrocarbon group having 12 or less carbon atoms and an alkoxy group having 12 or less carbon atoms are most preferable. Y¹ and Y², which may be the same or different, each represents a sulfur atom or a dialkylmethylene group having 12 or less carbon atoms. R³ and R⁴, which may be the same or different, each represents a hydrocarbon group having 20 or less carbon atoms, which may have a substituent. Preferable examples of the substituent include an alkoxy group having 12 or less carbon atoms, a carboxyl group and a sulfo group, and an alkoxy group having 12 or less carbon atoms is most preferable. R⁵, R⁶, R⁷ and R⁸, which may be the same or different, each represents a hydrogen atom or a hydrocarbon group having 12 or less carbon atoms. In view of the availability of raw materials, a hydrogen atom is preferred. Za⁻ represents a counter anion. However, Za⁻ is not necessary when the cyanine dye represented by formula (i) has an anionic substituent in the structure thereof and neutralization of charge is not needed. Preferable examples of the counter ion for Za⁻ include a halogen ion, a perchlorate ion, a tetrafluoroborate ion, a hexafluorophosphate ion and a sulfonate ion, and particularly preferable examples thereof include a perchlorate ion, a hexafluorophosphate ion and an arylsulfonate ion in view of the preservation stability of a coating solution for image-recording layer.

Specific examples of the cyanine dye represented by formula (i), which can be preferably used in the invention, include those described in Paragraph Nos. [0017] to [0019] of JP-A-2001-133969.

Further, other particularly preferable examples include specific indolenine cyanine dyes described in JP-A-2002-278057 described above.

Examples of the pigment for use in the invention include commercially available pigments and pigments described in Colour Index (C.I.), Saishin Ganryo Binran (Handbook of the Newest Pigments) compiled by Pigment Technology Society of Japan (1977), Saishin Ganryo Oyou Gijutsu (Newest Application on Technologies for Pigments), CMC Publishing Co., Ltd. (1986) and Insatsu Ink Gijutsu (Printing Ink Technology), CMC Publishing Co., Ltd. (1984).

Examples of the pigment include black pigments, yellow pigments, orange pigments, brown pigments, red pigments, purple pigments, blue pigments, green pigments, fluorescent pigments, metal powder pigments and polymer-bonded dyes. Specific examples of usable pigment include insoluble azo pigments, azo lake pigments, condensed azo pigments, chelated azo pigments, phthalocyanine pigments, anthraquinone pigments, perylene and perynone pigments, thioindigo pigments, quinacridone pigments, dioxazine pigments, isoindolinone pigments, quinophthalone pigments, dying lake pigments, azine pigments, nitroso pigments, nitro pigments, natural pigments, fluorescent pigments, inorganic pigments and carbon black. Of the pigments, carbon black is preferred.

The pigment may be used without undergoing surface treatment or may be used after the surface treatment. For the surface treatment, a method of coating the surface with a resin or wax, a method of attaching a surfactant and a method of bonding a reactive substance (for example, a silane coupling agent, an epoxy compound or polyisocyanate) to the pigment surface. The surface treatment methods are described in Kinzoku Sekken no Seisitsu to Oyo (Properties and Applications of Metal Soap), Saiwai Shobo, Insatsu Ink Gijutsu (Printing Ink Technology), CMC Publishing Co., Ltd. (1984), and Saishin Ganryo Oyo Gijutsu (Newest Application on Technologies for Pigments), CMC Publishing Co., Ltd. (1986),

The pigment has a particle size of preferably from 0.01 to 10 μm, more preferably from 0.05 to 1 μm, particularly preferably from 0.1 to 1 μm. In the above-described range, good stability of the pigment dispersion in the coating solution for image-recording layer and good uniformity of the image-recording layer can be obtained.

For dispersing the pigment, a known dispersion technique for use in the production of ink or toner may be used. Examples of the dispersing machine include an ultrasonic dispersing machine, a sand mill, an attritor, a pearl mill, a super-mill, a ball mill, an impeller, a disperser, a KD mill, a colloid mill, a dynatron, a tree roll mill and a pressure kneader. The dispering machines are described in detail in Saishin Ganryo Oyo Gijutsu (Newest Application on Technologies for Pigments), CMC Publishing Co., Ltd. (1986).

The ink absorbing agent may be added together with other components to one layer or may be added to a different layer separately provided. With respect to the amount of the infrared absorbing agent added, in the case of preparing a lithographic printing plate precursor, the amount is so controlled that absorbance of the image-recording layer at the maximum absorption wavelength in the wavelength region of 760 to 1,200 nm measured by reflection measurement is in a range of 0.3 to 1.2, preferably in a range of 0.4 to 1.1. In the above-described range, the polymerization reaction proceeds uniformly in the thickness direction of the image-recording layer and good film strength of the image area and good adhesion property of the image area to a support are achieved.

The absorbance of the image-recording layer can be controlled depending on the amount of the infrared absorbing agent added to the image-recording layer and the thickness of the image-recording layer. The measurement of the absorbance can be carried out in a conventional manner. The method for measurement includes, for example, a method of forming an image-recording layer having a thickness determined appropriately in the range necessary for the lithographic printing plate precursor on a reflective support, for example, an aluminum plate, and measuring reflection density of the image-recording layer by an optical densitometer or a spectrophotometer according to a reflection method using an integrating

### <(B) Polymerization Initiator>

The polymerization initiator for use in the invention is a compound that generates a radical with light energy, heat energy or both energies to initiate or accelerate polymerization of a compound having a polymerizable unsaturated group. The polymerization initiator for use in the invention includes, for example, known thermal polymerization initiators, compounds containing a bond having small bond dissociation energy and photopolymerization initiators. The compound generating a radical preferably used in the invention is a compound that generates a radical with heat energy to initiate or accelerate polymerization of a compound having a polymerizable unsaturated group. The thermal radical generator according to the invention is appropriately selected from known polymerization initiators and compounds containing a bond having small bond dissociation energy. The polymerization initiators can be used individually or in combination of two or more thereof.

The polymerization initiators include, for example, organic halides, carbonyl compounds, organic peroxides, azo compounds, azido compounds, metallocene compounds, hexaarylbiimidazole compounds, organic borate compounds, disulfonic acid compounds, oxime ester compounds and onium salt compounds.

The organic halides described above specifically include, for example, compounds described in Wakabayashi et al., Bull. Chem. Soc. Japan, 42, 2924 (1969), U.S. Pat. No. 3,905,815, JP-B-46-4605, JP-A-48-35281, JP-A-55-32070, JP-A-60-239736, JP-A-61-169835, JP-A-61-169837, JP-A-62-58241, JP-A-62-212401, JP-A-63-70243, JP-A-63-298339 and M. P. Hutt, Journal of Heterocyclic Chemistry, 1, No. 3 (1970). Particularly, oxazole compounds and s-triazine compounds each substituted with a trihalomethyl group are exemplified.

More preferably, s-triazine derivatives in which at least one of mono-, di- and tri-halogen substituted methyl groups is connected to the s-triazine ring are exemplified. Specific examples thereof include 2,4,6-tis(monochloromethyl)-s-triazine, 2,4,6-tris(dichloromethyl)-s-triazine, 2,4,6-tris(trichloromethyl)-s-triazine, 2-methyl-4,6-bis(trichloromethyl)-s-triazine, 2-n-propyl-4,6-bis(trichloromethyl)-s-triazine, 2-(α,α,βtrichloroethyl)-4,6-bis(trichloromethyl)-s-triazine, 2-phenyl-4,6-bis(trichloromethyl)-s-triazine, 2-(p-methoxyphenyl)-4,6-bis(trichloromethyl)-s-triazine, 2-(3,4epoxyphenyl)-4,6-bis(trichloromethyl)-s-triazine, 2-(p-chlorophenyl)-4,6-bis(trichloromethyl)-s-triazine, 2-(1-(p-methoxyphenyl)-2,4-butadienyl]-4,6-bis(trichloromethyl)-s-triazine, 2-styryl-4,6-bis(trichloromethyl)-s-triazine, 2-(p-methoxystyryl)-4,6-bis(trichloromethyl)-s-triazine, 2-(p-isopropyloxystyryl)-4,6-bis(trichloromethyl)-s-triazine, 2-(p-tolyl)-4,6-bis(trichloromethyl)-s-triazine, 2-(4-methoxynaphthyl)-4,6-bis(trichloromethyl)-s-triazine, 2-phenylthio-4,6-bis(trichloromethyl)-s-triazine, 2-benzylthio-4,6-bis(trichloromethyl)-s-triazine, 2,4,6-tris(dibromomethyl)-s-triazine, 2,4,6-tris(tribromomethyl)-s-triazine, 2-methyl-4,6-bis(tribromomethyl)-s-triazine and 2-methoxy-4,6-bis(tribromomethyl)-s-triazine.

The carbonyl compounds described above include, for example, benzophenone derivatives, e.g., benzophenone, Michler's ketone, 2-methylbenzophenone, 3-methylbenzophenone, 4-methylbenzophenone, 2-chlorobenzophenone, 4-bromobenzophenone or 2-carboxybenzophenone, acetophenone derivatives, e.g., 2,2-dimethoxy-2-phenylacetophenone, 2,2-diethoxyacetophenone, 1-hydroxycyclohexylphenylketone, α-hydroxy-2-methylphenylpropane, 1-hydroxy-1-methylethyl-(p-isopropylphenyl)ketone, 1-hydroxy-1-(p-dodecylphenyl)ketone, 2-methyl-(4′-methylthio)phenyl)-2-morpholino-1-propane or 1,1,1,-trichloromethyl-(p-butylphenyl)ketone, thioxantone derivatives, e.g., thioxantone, 2-ethylthioxantone, 2-isopropylthioxantone, 2-chlorothioxantone, 2,4-dimetylthioxantone, 2,4dietylthioxantone or 2,4-diisopropylthioxantone, and benzoic acid ester derivatives, e.g., ethyl p-dimethylaminobenzoate or ethyl p-diethylaminobenzoate.

The azo compounds described above include, for example, azo compounds described in JP-A-8-108621.

The organic peroxides described above include, for example, trimethylcyclohexanone peroxide, acetylacetone peroxide, 1,1-bis(tert-butylperoxy)-3,3,5-trimethylcyclohexane, 1,1-bis(tert-butylperoxy)cyclohexane, 2,2-bis(tert-butylperoxy)butane, tert-butylhydroperoxide, cumene hydroperoxide, diisopropylbenzene hydroperoxide, 2,5-dimethylhexane-2,5-dihydroperoxide, 1,1,3,3-tetramethylbutyl hydroperoxide, tert-butylcumyl peroxide, dicumyl peroxide, 2,5-dimethyl-2,5-di(tert-butylperoxy)hexane, 2,5-oxanoyl peroxide, succinic peroxide, benzoyl peroxide, 2,4-dichlorobenzoyl peroxide, diisopropylperoxy dicarbonate, di-2-ethylhexylperoxy dicarbonate, di-2-ethoxyethylperoxy dicarbonate, dimethoxyisopropylperoxy dicarbonate, di(3-methyl-3-methoxybutyl)peroxy dicarbonate, tert-butylperoxy acetate, tert-butylperoxy pivalate, tert-butylperoxy neodecanoate, tert-butylperoxy octanoate, tert-butylperoxy laurate, tersyl carbonate, 3,3′,4,4′-tetra(tert-butylperoxycarbonyl)benzophenone, 3,3′,4,4tetra(tert-hexylperoxycarbonyl)bezophenone, 3,3′,4,4′tetra(p-isopropylcumylperoxycarbonyl)benzophenone, carbonyl di(tert-butylperoxydihydrogen diphthalate) and carbonyl di(tert-hexylperoxydihydrogen diphthalate).

The metallocene compounds described above include, for example, various titanocene compounds described in JP-A-59-152396, JP-A-61-151197, JP-A-63-41484, JP-A-2-249, JP-A-2-4705 and JP-A-5-83588, for example, dicyclopentadienyl-Ti-bisphenyl, dicyclopendienyl-Ti-bis-2,6-difluorophen-1-yl, dicyclopentadienyl-Ti-bis-2,4-difluorophen-1-yl, dicyclopentadienyl-Ti-bis2,4,6-trifluorophen-1-yl, dicyclopentadienyl-Ti-bis-2,3,5,6-tetrafluorophen-1-yl, dicyclopentadienyl-Ti-bis-2,3,4,5,6-pentafluorophen-1-yl, dimethylcyclopentadienyl-Ti-bis-2,6-difluorophen-1-yl, dimethylcyclopentadienyl-Ti-bis-2,4,6-trifluorophen-1-yl, dimethylcyclopentadienyl-Ti-bis-2,3,5,6-tetrafluorophen-1-yl or dimethylcyclopentadienyl-Ti-bis-2,3,4,5,6-pentafluorophen-1-yl, and iron-arene complexes described in JP-A-1-304453 and JP-A-1-152109.

The hexaarylbiimidazole compounds described above include, for example, various compounds described in JP-B-6-29285 and U.S. Pat. Nos. 3,479,185, 4,311,783 and 4,622,286, specifically, for example, 2,2′-bis(o-chlorophenyl)-4,4′,5,5′-tetraphenylbiimidazole, 2,2′-bis(o-bromophenyl)-4,4′,5,5′-tetarphenylbiimdazole, 2,2′-bis(o,p-dichlorophenyl)4,4′,5,5′-tetraphenylbiimidazole, 2,2′-bis(o-chlorophenyl)-4,4′,5,5′-tetra(m-methoxyphenyl)biimidazole, 2,2′-bis(o,o′-dichlorophenyl)-4,4′,5,5′-tetraphenylbiimidazole, 2,2′-bis(o-nitrophenyl)4,4′,5,5′-tetraphenylbiimidazole, 2,2′-bis(o-methylphenyl)-4,4′,5,5′-tetraphenylbiimidazole or 2,2′-bis(o-trifluoromethylphenyl)4,4′,5,5′-tetraphenylbiimidazole.

The organic borate compounds described above include, for example, organic borates described in JP-A-62-143044, JP-A-62-150242, JP-A-9-188685, JP-A-9-188686, JP-A-9-188710, JP-A-2000-131837, JP-A-2002-107916, Japanese Patent 2,764,769, JP-A-2002-116539 and Martin Kunz, Rad Tech '98, Proceeding, Apr. 19-22 (1998), Chicago, organic boron sulfonium complexes or organic boron oxosulfonium complexes described in JP-A-6-157623, JP-A-6-175564 and JP-A-6-175561, organic boron iodonium complexes described in JP-A-6-175554 and JP-A-6-175553, organic boron phosphonium complexes described in JP-A-9-188710, and organic boron transition metal coordination complexes described in JP-A-6-348011, JP-A-7-128785, JP-A-7-140589, JP-A-7-306527 and JP-A-7-292014.

The disulfone compounds described above include, for example, compounds described in JP-A-61-166544 and JP-A-2002-328465.

The oxime ester compounds described above include, for example, compounds described in J. C. S. Perkin II, 1653-1660 (1979), J. C. S. Perkin II, 156-162 (1979), Journal of Photopolymer Science and Technology, 202-232 (1995) and JP-A-2000-66385, and compounds described in JP-A-2000-80068. Specific examples thereof include compounds represented by the following structural formulae:

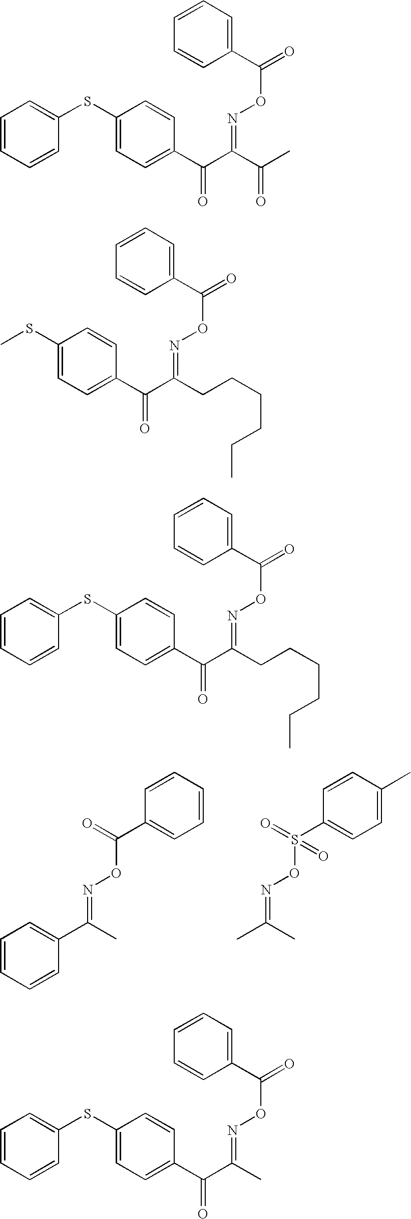

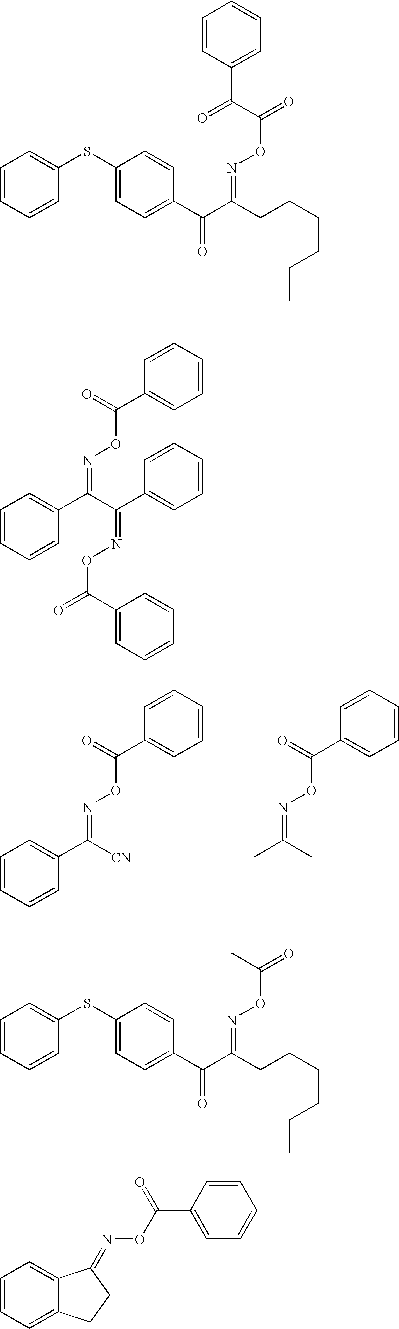

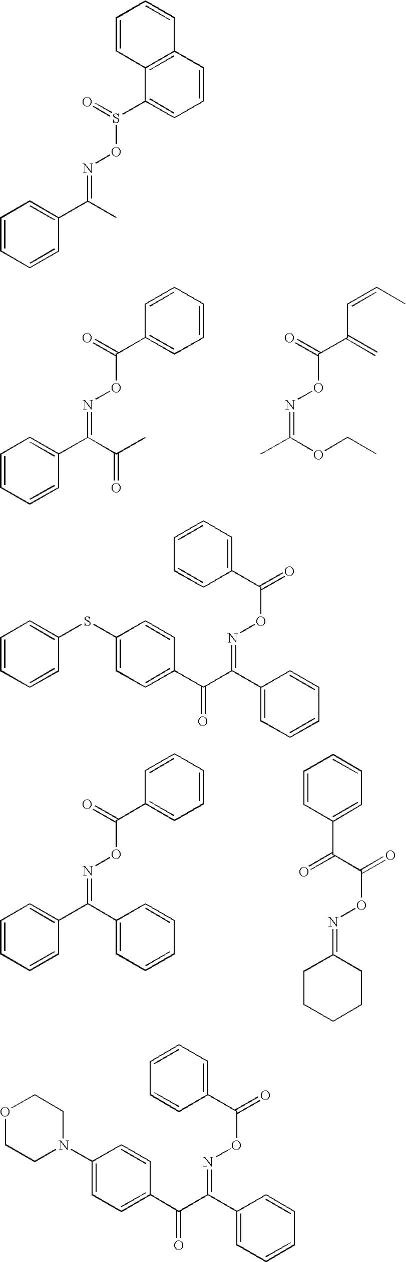

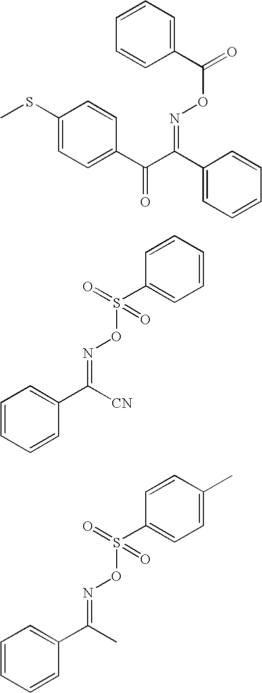

The onium salt compounds described above include, for example, diazonium salts described in S. I. Schlesinger, Photogr. Sci. Eng., 18, 387 (1974) and T. S. Bal et al., Polymer, 21, 423 (1980), ammonium salts described in U.S. Pat. No. 4,069,055 and JP-A-4-365049, phosphonium salts described in U.S. Pat. Nos. 4,069,055 and 4,069,056, iodonium sats described in European Patent 104,143, U.S. Pat. Nos. 339,049 and 410,201, JP-A-2-150848 and JP-A-2-296514, sulfonium salts described in European Patent 370,693, 390,214, 233,567, 297,443 and 297,442, U.S. Pat. Nos. 4,933,377, 161,811, 410,201, 339,049, 4,760,013, 4,734,444 and 2,833,827 and German Patents 2,904,626, 3,604,580 and 3,604,581, selenonium salts described in J. V. Crivello et al., Macromolecules, 10 (6), 1307 (1977) and J. V. Crivello et al., J. Polymer Sci., Polymer Chem Ed., 17, 1047 (1979), and arsonium salts described in C. S. Wen et al., Teh, Proc. Conf. Rad. Curing ASIA p. 478, Tokyo, October (1988).

Particularly, in view of reactivity and stability, the oxime ester compounds and diazonium compounds, iodonium compounds and sulfonium compounds described above are exemplified. In the invention, the onium salt functions not as an acid generator, but as an ionic radical polymerization initiator.

The onium salts preferably used in the invention include onium salt represented by the following formulae (RI-I) to (RI-III):

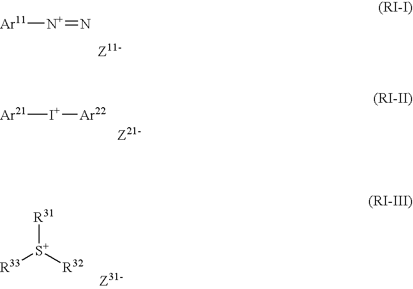

In formula (RI-I), Ar¹¹ represents an aryl group having 20 or less carbon atoms, which may have 1 to 6 substituents. Preferable example of the substituent includes an alkyl group having from 1 to 12 carbon atoms, an alkenyl group having from 1 to 12 carbon atoms, an alkynyl group having from 1 to 12 carbon atoms, an aryl group having from 1 to 12 carbon atoms, an alkoxy group having from 1 to 12 carbon atoms, an aryloxy group having from 1 to 12 carbon atoms, a halogen atom, an alkylamino group having from 1 to 12 carbon atoms, a dialkylimino group having from 1 to 12 carbon atoms, an alkylamido group or arylamido group having from 1 to 12 carbon atoms, a carbonyl group, a carboxyl group, a cyano group, a sulfonyl group, an thioalkyl group having from 1 to 12 carbon atoms and an thioaryl group having from 1 to 12 carbon atoms. Z¹¹⁻ represents a monovalent anion and specifically includes a halogen ion, a perchlorate ion, a hexafluorophosphate ion, a tetrafluoroborate ion, a sulfonate ion, a sulfinate ion, a thosulfonate ion and a sulfate ion. From the standpoint of stability, a perchlorate ion, a hexafluorophosphate ion, a tetrafluoroborate ion, a sulfonate ion or a sulfinate ion is preferable.

In the formula (RI-II), Ar²¹ and Ar²² each independently represents an aryl group having 20 or less carbon atoms, which may have 1 to 6 substituents. Preferable example of the substituent includes an alkyl group having from 1 to 12 carbon atoms, an alkenyl group having from 1 to 12 carbon atoms, an alkynyl group having from 1 to 12 carbon atoms, an aryl group having from 1 to 12 carbon atoms, an alkoxy group having from 1 to 12 carbon atoms, an aryloxy group having from 1 to 12 carbon atoms, a halogen atom, an alkylamino group having from 1 to 12 carbon atoms, a dialkylimino group having from 1 to 12 carbon atoms, an alkylalamido group or arylamido group having from 1 to 12 carbon atoms, a carbonyl group, a carboxyl group, a cyano group, a sulfonyl group, an thioalkyl group having from 1 to 12 carbon atoms and an thioaryl group having from 1 to 12 carbon atoms. Z²¹⁻ represents a monovalent anion and specifically includes a halogen ion, a perchlorate ion, a hexafluorophosphate ion, a tetrafluoroborate ion, a sulfonate ion, a sulfinate ion, a thosulfonate ion, a sulfate ion and a carboxylate ion. From the standpoint of stability and reactivity, a perchlorate ion, a hexafluorophosplate ion, a tetrafluoroborate ion, a sulfonate ion, a sulfinate ion or a carboxylate ion is preferable.

In the formula (RI-III), R³¹ , R³² and R³³ each independently represents an aryl group having 20 or less carbon atoms, which may have 1 to 6 substituents, an alkyl group, an alkenyl group or an alkynyl group and is preferably an aryl group from the standpoint of reactivity and stability. Preferable example of the substituent includes an alkyl group having from 1 to 12 carbon atoms, an alkenyl group having from 1 to 12 carbon atoms, an alkynyl group having from 1 to 12 carbon atoms, an aryl group having from 1 to 12 carbon atoms, an alkoxy group having from 1 to 12 carbon atoms, an aryloxy group having from 1 to 12 carbon atoms, a halogen atom, an alkylamino group having from 1 to 12 carbon atoms, a dialkylimino group having from 1 to 12 carbon atoms, an alkylamido group or arylamido group having from 1 to 12 carbon atoms, a carbonyl group, a carboxy group, a cyano group, a sulfonyl group, an thioalkyl group having from 1 to 12 carbon atoms and an thioaryl group having from 1 to 12 carbon atoms, Z³¹⁻ represents a monovalent anion and specifically includes a halogen ion, a perchlorate ion, a hexafluorophosphate ion, a tetrafluoroborate ion, a sulfonate ion, a sulfinate ion, a thosulfonate ion, a sulfate ion and a carboxylate ion. From the standpoint of stability and visual inspection property, a perchlorate ion, a hexafluorophosphate ion, a tetrafluoroborate ion, a sulfonate ion, a sulfinate ion or a carboxylate ion is preferable. Carboxylate ions described in JP-A-2001-343742 are more preferable, and carboxylate ions described in JP-A-2002-148790 are particularly preferable.

Specific examples of the onium salt compound preferably used as the polymerization initiator in the invention are set forth below, but the invention should not be construed as being limited thereto.

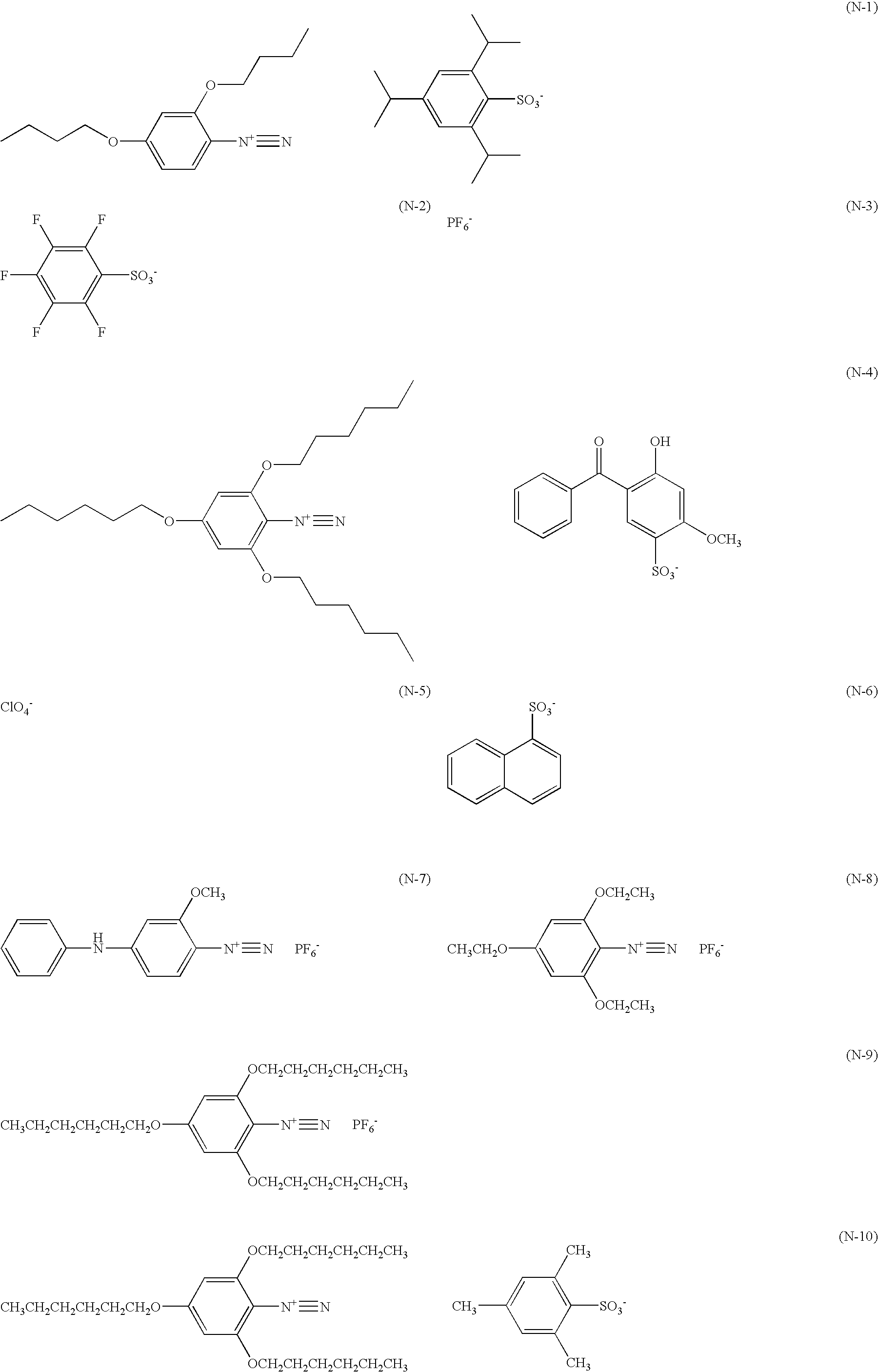

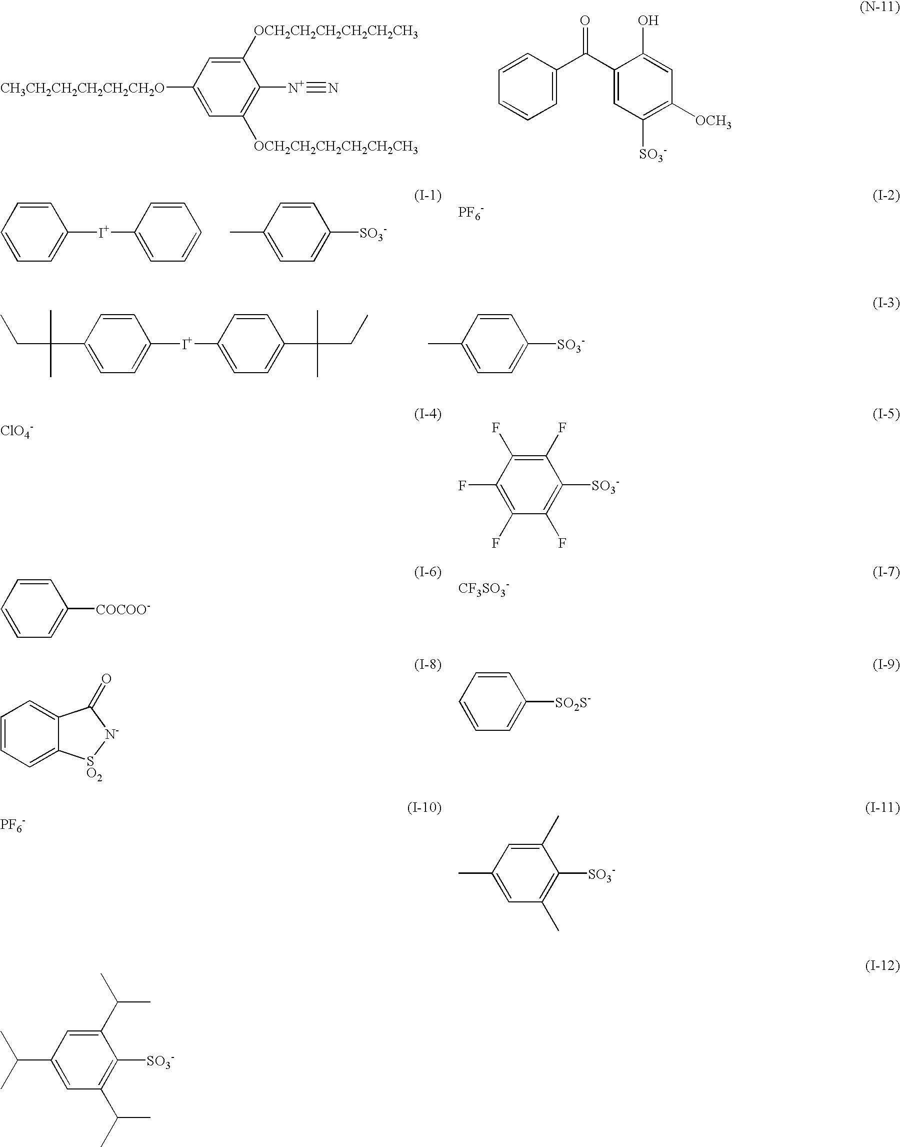

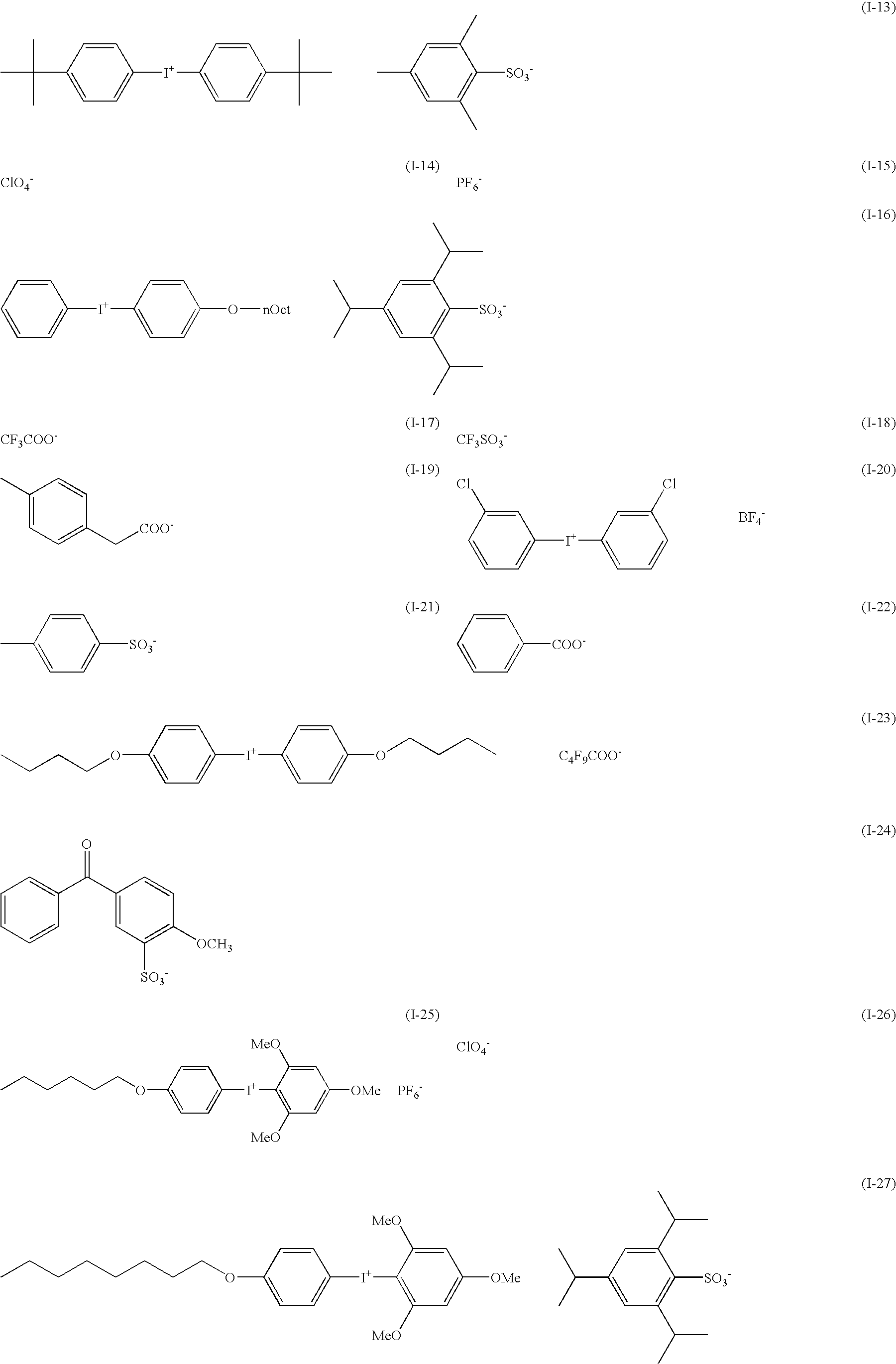

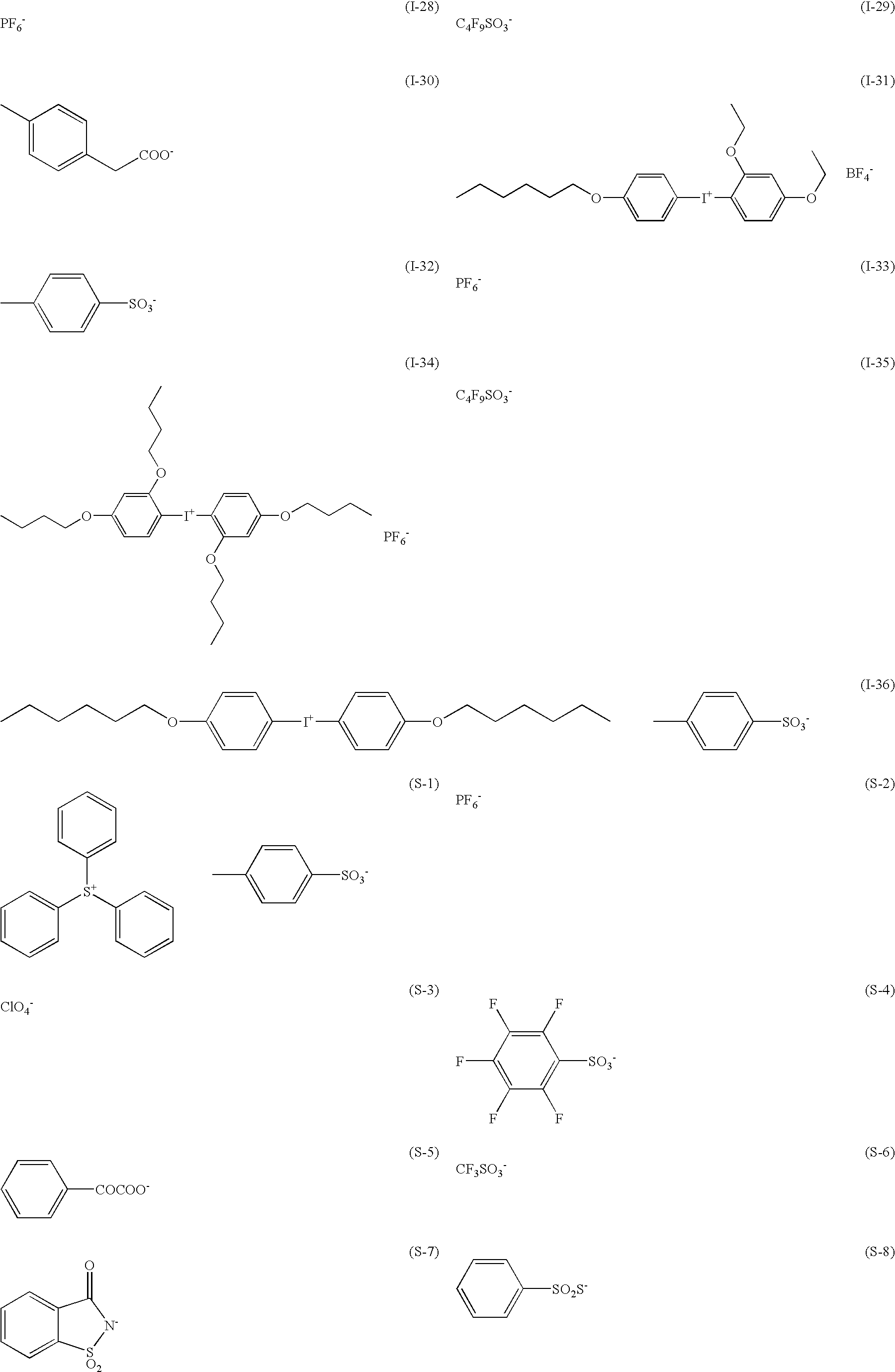

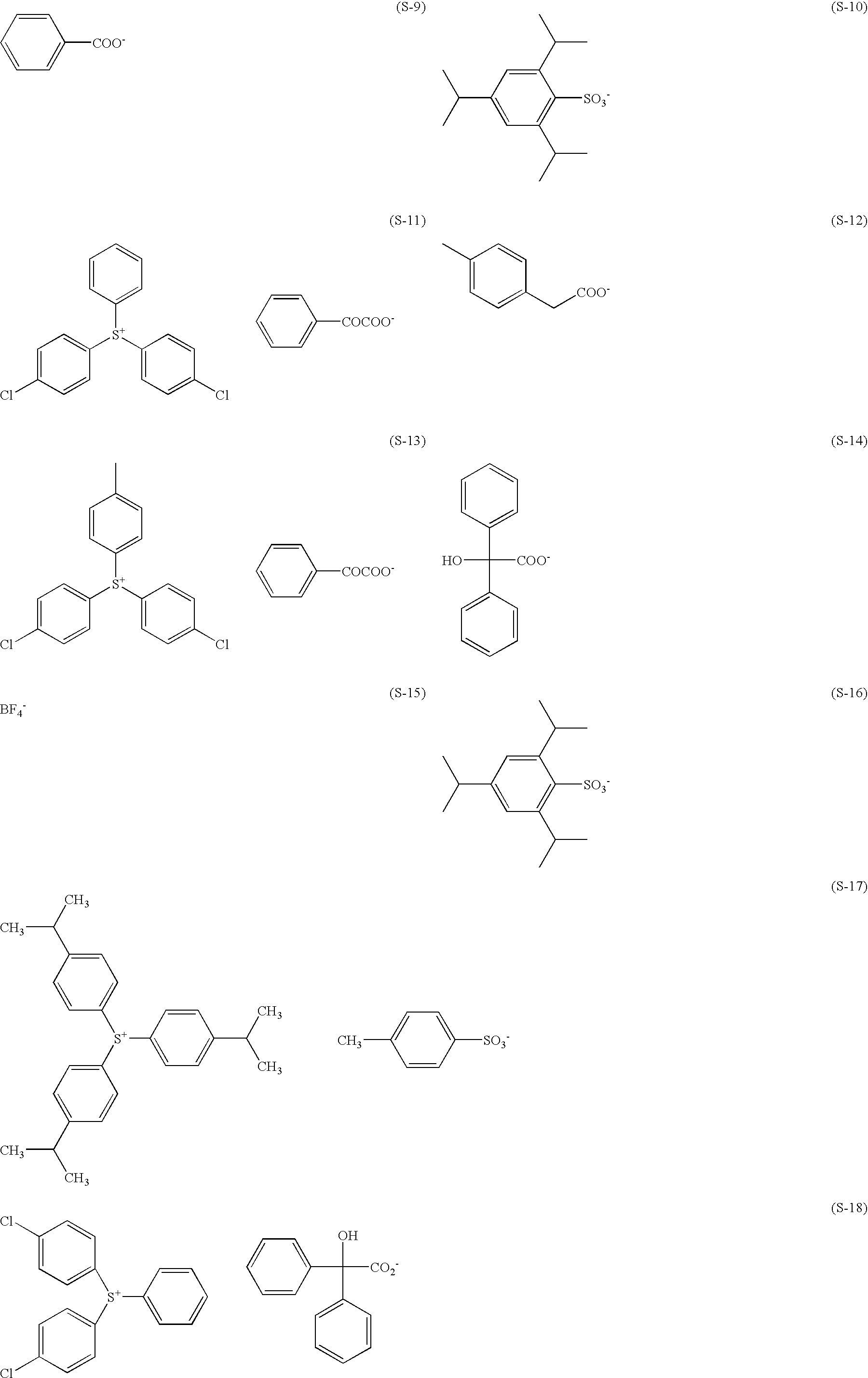

The polymerization initiator can be added ordinarily in an amount from 0.1 to 50% by weight, preferably from 0.5 to 30% by weight, particularly preferably from 1 to 20% by weight, based on the total solid content constituting the image-recording layer. In the above-described range, good sensitivity and good stain resistance in the non-image area at the time of printing can be achieved. The polymerization initiators may be used individually or in combination of two or more thereof. Also, the polymerization initiator may be added together with other components in one layer or may be added to a different layer separately provided.

### <(C) Polymerizable Compound>

The polymerizable compound which can be used in the invention is an addition-polymerizable compound having at least one ethylenically unsaturated double bond and it is selected from compounds having at least one, preferably two or more, terminal ethylenically unsaturated double bonds. Such compounds are widely known in the field of art and they can be used in the invention without any particular limitation. The compound has a chemical form, for example, a monomer, a prepolymer, specifically, a dimer, a trimer or an oligomer, or a copolymer thereof, or a mixture thereof. Examples of the monomer and copolymer thereof include unsaturated carboxylic acids (for example, acrylic acid, methacrylic acid, itaconic acid, crotonic acid, isocrotonic acid or maleic acid) and esters or amides thereof. Preferably, esters of an unsaturated carboxylic acid with an aliphatic polyhydric alcohol compound and amides of an unsaturated carboxylic acid with an aliphatic polyvalent amine compound are used. An addition reaction product of an unsaturated carboxylic acid ester or amide having a nucleophilic substituent, for example, a hydroxy group, an amino group or a mercapto group, with a monofunctional or polyfunctional isocyanite or epoxy, or a dehydration condensation reaction product of the unsaturated carboxylic acid ester or amide with a monofunctional or polyfunctional carboxylic acid is also preferably used. Furthermore, an addition reaction product of an unsaturated carboxylic acid ester or amide having an electrophilic substituent, for example, an isocyanato group or an epoxy group with a monofunctional or polyfunctional alcohol, amine or thiol, or a substitution reaction product of an unsaturated carboxylic acid ester or amide having a releasable substituent, for example, a halogen atom or a tosyloxy group with a monofunctional or polyfunctional alcohol, amine or thiol is also preferably used. In addition, compounds in which the unsaturated carboxylic acid described above is replaced by an unsaturated phosphonic acid, styrene, vinyl ether or the like can also be used.

Specific examples of the monomer, which is an ester of an aliphatic polyhydric alcohol compound with an unsaturated carboxylic acid, include acrylic acid esters, for example, ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl) ether, trimethylolethane triacrylate, hexanediol diacrylate, 1,4-cyclohexanediol diacrylate, tetraethylene glycol diacrylate pentaerythritol, diacrylate, pentaerythritol triacrylate, pentaerythritol tetraacrylate, dipentaerylthritol diacrylate, dipentaerythritol hexaacrylate, sorbitol triacrylate, sorbitol tetraacrylate, sorbitol pentaacrylate, sorbitol hexaacrylate, tri(acryloyloxyethyl) isocyanurate, polyester acrylate oligomer or isocyanuric acid EO modified triacrylate; methacrylic acid esters, for example, tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane or bis[p-(methacryloxyethoxy)phenyl]dimethylmethane; itaconic acid esters, for example, ethylene glycol diitaconate, propylene glycol diitaconate, 1,3-butanediol diitaconate, 1,4-butanediol diitaconate, tetramethylene glycol diitaconate, pentaerythritol diitaconate or sorbitol tetraitaconate; crotonic acid esters, for example, ethylene glycol dicrotonate, tetramethylene glycol dicrotonate, pentaerythritol dicrotonate or sorbitol tetradicrotonate; isocrotonic acid esters, for example, ethylene glycol diisocrotonate, pentaerythritol diisocrotonate or sorbitol tetraisocrotonate; and maleic acid esters, for example, ethylene glycol dimaleate, triethylene glycol dimaleate, pentaerythritol dimaleate and sorbitol tetramaleate.

Other examples of the ester, which can be preferably used, include aliphatic alcohol esters described in JP-B-51-47334 and JP-A-57-196231, esters having an aromatic skeleton described in JP-A-59-5240, JP-A-59-5241 and JP-A-2-226149, and esters containing an amino group described in JP-A-1-165613.

The above described ester monomers can also be used as a mixture.

Specific examples of the monomer, which is an amide of an aliphatic polyvalent amine compound with an unsaturated carboxylic acid, include methylene bisacrylamide, methylene bismethacrylamide, 1,6-hexamethylene bisacrylamide, 1,6-hexamethylene bismethacrylamide, diethylenetriamine tisacrylamide, xylylene bisacrylamide and xylylene bismethacrylamide. Other preferable examples of the amide monomer include amides having a cyclohexylene structure described in JP-B-54-21726.

Urethane type addition polymerizable compounds produced using an addition reaction between an isocyanate and a hydroxy group are also preferably used, and specific examples thereof include vinylurethane compounds having two or more polymerizable vinyl groups per molecule obtained by adding a vinyl monomer containing a hydroxy group represented by formula (A) shown below to a polyisocyanate compound having two or more isocyanate groups per molecule, described in JP-B-48-41708.

CH₂═C(R⁴)COOCH₂CH(R⁵)OH (A)

wherein R⁴ and R⁵ each independently represents H or CH₃.

Also, urethane acrylates described in JP-A-51-37193, JP-B-2-32293 and JP-B-2-16765, and urethane compounds having an ethylene oxide skeleton described in JP-B-58-49860, JP-B-56-17654, JP-B-62-39417 and JP-B-62-39418 are preferably used. Furthermore, a photopolymerizable composition having remarkably excellent photosensitive speed can be obtained by using an addition polymerizable compound having an amino structure or a sulfide structure in its molecule, described in JP-A-63-277653, JP-A-63-260909 and JP-A-1-105238.

Other examples include polyfunctional acrylates and methacrylates, for example, polyester acrylates and epoxy acrylates obtained by reacting an epoxy resin with acrylic acid or methacrylic acid, described in JP-A-48-64183, JP-B-49-43191 and JP-B-52-30490. Specific unsaturated compounds described in JP-B-46-43946, JP-B-1-40337 and JP-B-1-40336, and vinylphosphonic acid type compounds described in JP-A-2-25493 can also be exemplified. In some cases, structure containing a perfluoroalkyl group described in JP-A-61-22048 can be preferably used. Moreover, photocurable monomers or oligomers described in Nippon Secchaku Kyokaishi (Journal of Japan Adhesion Society), Vol. 20, No. 7, pages 300 to 308 (1984) can also be used.

Details of the method of using the polymerizable compound, for example, selection of the structure, individual or combination use, or an amount added, can be appropriately arranged depending on the characteristic design of the final lithographic printing plate precursor. For instance, the compound is selected from the following standpoints.

In view of the sensitivity, a structure having a large content of unsaturated groups per molecule is preferred and in many cases, a bifunctional or more functional compound is preferred. In order to increase the strength of image area, that is, hardened layer, a trifunctional or more functional compound is preferred. A combination use of compounds different in the functional number or in the kind of polymerizable group (for example, an acrylic acid ester, a methacrylic acid ester, a styrene compound or a vinyl ether compound) is an effective method for controlling both the sensitivity and the strength.

The selection and use method of the polymerizable compound are also important factors for the compatibility and dispersibility with other components (for example, a binder polymer, a polymerization initiator or a coloring agent) in the image-recording layer. For instance, the compatibility may be improved in some cases by using the compound of low purity or using two or more kinds of the compounds in combination. A specific structure may be selected for the purpose of improving an adhesion property to a support or an overcoat layer described hereinafter. The polymerizable compound is preferably used in an amount from 5 to 80% by weight, more preferably from 25 to 75% by weight, based on the nonvolatile component of the image-recording layer. The polymerizable compounds may be used individually or in combination of two or more thereof. In the method of using the polymerizable compound, the structure, blend and amount added can be appropriately selected by taking account of the extent of polymerization inhibition due to oxygen, resolution, fogging property, change in refractive index, surface tackiness and the like. Further, depending on the case, a layer construction, for example, an undercoat layer or an overcoat layer, and a coating method, may also be considered.

### <(D) Fine Polymer Particle Hang Polymerizable Reactive Group>

The image-recording layer according to the invention preferably includes (D) a fine polymer particle having a polymerizable reactive group in addition to the above-described constituting components (A) to (C) of the image-recording layer.

The fine polymer particle having a polymerizable reactive group for use in the image-recording layer according to the invention includes fine particle of a polymer containing a monomer unit having an acryloyl group, a methacryloyl group, a vinyl group or an allyl group in its chain. The introduction of the functional group into the fine polymer particle may be conducted at the polymerization or may be conducted by utilizing a polymer reaction after the polymerization.

When the functional group is introduced at the polymerization, it is preferred that the monomer having the polymerizable functional group is subjected to emulsion polymerization, suspension polymerization or polycondensation reaction, for example, urethanation. If desired, a monomer having no polymerizable reactive group is also added as a copolymer component.

Specific examples of the monomer having the functional group include alkyl methacrylate, alkyl acrylate, vinyl methacrylate, vinyl acrylate, glycidyl methacrylate, glycidyl acrylate, 2-isocyanatoethyl methacrylate, 2-isocyanatoethyl acrylate, 2-aminoethyl methacrylate, 2-aminoethyl acrylate, 2-hydroxyethyl methacrylate, 2-hydroxyethyl acrylate, acrylic acid, methacrylic acid, maleic anhydride, a difunctional acrylate and a difunctional methacrylate, but the invention should not be construed as being limited to thereto.

As the polymer reaction used in the case where the polymerizable reactive functional group is introduced after the polymerization, polymer reactions described, for example, in WO 96/34316 can be exemplified.

The fine polymer particles having the polymerizable reactive group described above may be coalesced with each other by heat. Further, a fine polymer particle having a hydrophilic surface and dispersible in water is particularly preferable. For making the surface of fine polymer particle hydrophilic, it is effective to let a hydrophilic polymer or oligomer, for example, polyvinyl alcohol or polyethylene glycol, or a hydrophilic low molecular compound adsorb on the surface of the fine polymer particle. However, the method for hydrophilizing the surface should not be construed as being limited thereto.

The average particle size of the fine polymer particle is preferably from 0.01 to 10 μm, more preferably from 0.05 to 2 and particularly preferably from 0.1 to 1 μm. When the average particle size is too large, the resolution deteriorates and whereas, it is too small, the preservation stability degrades.

As the form of the fine polymer particle having the polymerizable reactive group, a form wherein a covalent bond with the compound having the polymerizable reactive group is not formed, for example, microcapsule or microgel including the compound having the polymerizable reactive group is also exemplified.

Specifically, according to the invention, several embodiments can be employed in order to incorporate the above-described constituting components (A) to (C) of the image-recording layer and other constituting components described hereinafter into the image-recording layer. One embodiment is the image-recording layer of molecular dispersion type prepared by dissolving the constituting components in an appropriate solvent to coat as described, for example, in JP-A-2002-287334. Another embodiment is the image-recording layer of microcapsule type prepared by encapsulating all or part of the constituting components into microcapsule to incorporate into the image-recording layer as described, for example, in JP-A-2001-277740 and JP-A-2001-277742. In the image-recording layer of microcapsule type, the constituting components may be present outside the microcapsules. It is a more preferable embodiment of the image-recording layer of microcapsule type that the hydrophobic constituting components are encapsulated in microcapsules and the hydrophilic constituting components are present outside the microcapsules. In order to achieve more preferable on-machine development property, the image-recording layer is preferably the image-recording layer of microcapsule type.

The microcapsule or microgel as the form of fine polymer particle having the polymerizable reactive group includes the compound having the polymerizable reactive group. As the compound having the polymerizable reactive group, the compound described in the polymerizable compound (C) can be used without any limitation.

As the method of microencapsulation of the constituting components of the image-recording layer, known methods can be used. Methods of producing the microcapsule include, for example, a method of utilizing coacervation described in U.S. Pat. Nos. 2,800,457 and 2,800,458, a method of using interfacial polymerization described in U.S. Pat. No. 3,287,154, JP-B-38-19574 and JP-B-42-446, a method of using deposition of polymer described in U.S. Pat. Nos. 3,418,250 and 3,660,304, a method of using an isocyanate polyol wall material described in U.S. Pat. No. 3,796,669, a method of using an isocyanate wall material described in U.S. Pat. No. 3,914,511, a method of using a urea-formaldehyde-type or urea-formaldehyde-resorcinol-type wall-forming material described in U.S. Pat. Nos. 4,001,140, 4,087,376 and 4,089,802, a method of using a wall material, for example, a melamine-formaldehyde resin or hydroxycellulose described in U.S. Pat. No. 4,025,445, an in-situ method by monomer polymerization described in JP-B-36-9163 and JP-B-51-9079, a spray drying method described in British Patent 930,422 and U.S. Pat. No. 3,111,407, and an electrolytic dispersion cooling method described in British Patent 952,807 and 967,074, but the invention should not be construed as being limited thereto.

A preferable microcapsule wall used in the invention has three-dimensional crosslinking and has a solvent-swellable property. From this point of view, a preferable wall material of the microcapsule includes polyurea, polyurethane, polyester, polycarbonate, polyamide and a mixture thereof, and polyurea and polyurethane are particularly preferred. Further, the compound having the polymerizable reactive group may be introduced into the microcapsule wall.

The average particle size of the microcapsule is preferably from 0.01 to 10 μm, more preferably from 0.05 to 2 μm, and particularly preferably from 0.1 to 1 μm. When the average particle size is too large, the resolution deteriorates and whereas, it is too small, the preservation stability degrades.

The microcapsules may be coalesced with each other by heat or may not be coalesced.

### <Binder Polymer>

The binder polymer for use in the invention can be selected from those heretofore known without restriction, and a polymer having a film forming property is preferable. Examples of the binder polymer include acrylic resins, polyvinyl acetal resins, polyurethane resins, polyurea resins, polyimide resins, polyamide resins, epoxy resin, methacrylic resins, polystyrene resins, novolac type phenolic resins, polyester resins, synthesis rubbers and natural rubbers.

The binder polymer may have a crosslinkable property in order to improve the film strength of the image area. In order to impart the crosslinkable property to the binder polymer, a crosslinkable functional group, for example, an ethylenically unsaturated bond is introduced into the main chain or side chain of the polymer. The crosslinkable functional group may be introduced by copolymerization.

Examples of the polymer having an ethylenically unsaturated bond in the main chain thereof include poly-1,4-butadiene and poly-1,4-isoprene.

Examples of the polymer having an ethylenically unsaturated bond in the side chain thereof include a polymer of an ester or amide of acrylic acid or methacrylic acid, which is a polymer wherein the ester or amide residue R in —COOR or —CONHR) has an ethylenically unsaturated bond.

Examples of the residue (R described above) having an ethylenically unsaturated bond include —(CH₂)ₙCR¹═CR²R³, —(CH₂O)ₙCH₂CR¹═CR²R³, —(CH₂CH₂O)ₙCH₂CR¹═CR²R³, —(CH₂)ₙNH—CO—CH₂CR¹═CR²R³, —(CH₂)ₙ—O—CO—CR¹═CR²R³ and —(CH₂CH₂O)₂—X (wherein R¹ to R³ each represents a hydrogen atom, a halogen atom or an alkyl group having from 1 to 20 carbon atoms, an aryl group, alkoxy group or aryloxy group, or R¹ and R² or R¹ and R³ may be combined with each other to form a ring. n represents an integer of 1 to 10. X represents a dicyclopentadienyl residue).

Specific examples of the ester residue include —CH₂CH═CH₂ (described in JP-B-7-21633), —CH₂CH₂O—CH₂CH═CH₂, —CH₂C(CH₃)═CH₂, —CH₂CH═CH—C₆C₅, —CH₂CH₂OCOCH═CH—C₆H₅, —CH₂CH₂—NHCOO—CH₂C═CH₂ and —CH₂CH₂O—X (wherein X represents a dicyclopentadienyl residue).

Specific examples of the amide residue include —CH₂CH═CH₂, —CH₂CH₂—Y (wherein Y represents a cyclohexene residue) and —CH₂CH₂—OCO—CH═CH₂.

The binder polymer having crosslinkable property is hardened, for example, by adding a free radical (a polymerization initiating radical or a growing radical of a polymerizable compound during polymerization) to the crosslinkable functional group of the polymer and undergoing addition polymerization between the polymers directly or through a polymerization chain of the polymerizable compound to form crosslinkage between the polymer molecules. Alternately, it is hardened by generation of a polymer radical upon extraction of an atom in the polymer (for example, a hydrogen atom on a carbon atom adjacent to the functional crosslinkable group) by a fee radial and connecting the polymer radicals with each other to form cross-linkage between the polymer molecules.

The content of the crosslinkable group in the binder polymer (content of the radical polymerizable unsaturated double bond determined by iodine titration) is preferably from 0.1 to 10.0 mmol, more preferably from 1.0 to 7.0 mmol and most preferably from 2.0 to 5.5 mmol, based on 1 g of the binder polymer. In the above-described range good sensitivity and good preservation stability can be achieved.

From the standpoint of improvement in the on-machine development property of the unexposed area of the image-recording layer, it is preferred that the binder polymer has high solubility or dispersibility in ink and/or dampening water. In order to improve the solubility or dispersibility in the ink the binder polymer is preferably oleophilic and in order to improve the solubility or dispersibility in the dampening water; the binder polymer is preferably hydrophilic. Therefore, it is also effective in the invention that an oleophilic binder polymer and a hydrophilic binder polymer are used in combination.

The hydrophilic binder polymer preferably includes, for example, a polymer having a hydrophilic group, for example, a hydroxy group, a carboxyl group, a carboxylate group, a hydroxyethyl group, a polyoxyethyl group, a hydroxypropyl group, a polyoxypropyl group, an amino group, an aminoethyl group, an aminopropyl group, an ammonium group, an amido group, a carboxymethyl group, a sulfonic acid group or a phosphoric acid group.

Specific examples of the hydrophilic binder polymer include gum arabic, casein, gelatin, a starch derivative, carboxy methyl cellulose and sodium salt thereof, cellulose acetate, sodium alginate, a vinyl acetate-maleic acid copolymer, a styrene-maleic acid copolymer, polyacrylic acid and salt thereof, polymethacrylic acid and salt thereof, a homopolymer or copolymer of hydroxyethyl methacrylate, a homopolymer or copolymer of hydroxyethyl acrylate, a homopolymer or copolymer of hydroxypropyl methacrylate, a homopolymer or copolymer of hydroxypropyl acrylate, a homopolymer or copolymer of hydroxybutyl methacrylate, a homopolymer or copolymer of hydroxybutyl acrylate, a polyethylene glycol, a hydroxypropylene polymer, polyvinyl alcohol, a hydrolyzed polyvinyl acetate having a hydrolysis degree of 60% by mole or more, preferably 80% by mole or more, polyvinyl formal, polyvinyl butyral, polyvinyl pyrrolidone, a homopolymer or copolymer of acrylamide, a homopolymer or polymer of methacrylamide, a homopolymer or copolymer of N-methylolacrylamide, polyvinyl pyrrolidone, an alcohol-soluble nylon, a polyether of 2,2-bis-(4-hydroxyphenyl)propane and epichlorohydrin.

The weight average molecular weight of the binder polymer is preferably 5,000 or more, more preferably from 10,000 to 300,000. The number average molecular weight of the binder polymer is preferably 1,000 or more, more preferably from 2,000 to 250,000. The polydispersity (weight average molecular weight/number average molecular weight) of the binder polymer is preferably from 1.1 to 10.

The binder polymer can be synthesized according to conventionally known methods. A solvent used for the synthesis include, for example, tetrahydrofuran, ethylene dichloride, cyclohexanone, methyl ethyl ketone, acetone, methanol, ethanol ethylene glycol monomethyl ether, ethylene glycol monoethyl ether, 2-methoxyethyl acetate, diethylene glycol dimethyl ether, 1-methoxy-2-propanol, 1-methoxy-2-propylacetate, N,N-dimethylformamide, N,N-dimethylacetoamide, toluene, ethyl acetate, methyl lactate, ethyl lactate, dimethylsulfoxide and water. The solvents may be used individually or as a mixture of two or more thereof.

As a radical polymerization initiator used for the synthesis of binder polymer, a known compound, for example, an azo type initiator or a peroxide initiator can be employed.

The content of the binder polymer is ordinarily from 5 to 90% by weight, more preferably from 5 to 80% by weight, still more preferably om 10 to 70% by weight, based on the total solid content of the image-recording layer. In the above-described range, good strength of the image area and good image-forming property can be achieved.

It is preferred that the polymerizable compound (C) and the binder polymer are used in the amount so as to be the weight ratio of 0.5/1 to 4/1.

### <Surfactant>

In the image-recording layer according to the invention, a surfactant is preferably used in order to accelerate the on-machine development property at the initiation of printing and to improve the state of coated spice. The surfactant used includes, for example, a nonionic surfactant, an aonic surfactant, a cationic surfactant, an amphoteric surfactant and a fluorine-based surfactant. The surfactants may be used individually or in combination of two or more thereof.

The nonionic surfactant used in the invention is not particular restricted, and those hitherto known can be used. Examples of the nonionic surfactant include polyoxyethylene alkyl ethers, polyoxyethylene alkyl phenyl ethers, polyoxyethylene polystyryl phenyl ethers, polyoxyethylene polyoxypropylene alkyl ethers, glycerin fatty acid partial esters, sorbitan fatty acid partial esters, pentaerythritol fatty acid partial esters, propylene glycol monofatty acid esters, sucrose fatty acid partial esters, polyoxyethylene sorbitan fatty acid partial esters, polyoxyethylene sorbitol fatty acid partial esters, polyethylene glycol fatty acid esters, polyglycerol fatty acid partial esters, polyoxyethylenated castor oils, polyoxyethylene glycerol fatty acid partial esters, fatty acid diethanolamides, N,N-bis-2-hydroxyalkylamines, polyoxyethylene alkylamines, trietanolamine fatty acid esters, trialylamine oxides, polyethylene glycols and copolymers of polyethylene glycol and polypropylene glycol.

The anionic surfactant used in the invention is not particularly resticted and those hiterto known can be used. Examples of the anionic surfactant include fatty acid salts, abietic acid salts, hydroxyalkanesulfonic acid salts, alkanesulfonic acid salts, dialkylsulfosuccinic ester salts, staight-chain alkylbenzenesulfonic acid salts, branched alkylbenzenesulfonic acid salts, alkylnaphthalenesulfonic acid salts, alkylphenoxypolyoxyethylene propylsulfonic acid salts, polyoxyethylene alkylsulfophenyl ether salts, N-methyl-N-oleyltaurine sodium salt, N-alkylsulfosuccinic monoamide disodiun salts, petroleum sulfonic acid salts, sulfated beef tallow oil, sulfate ester slats of fatty acid alkyl ester, alkyl sulfate ester salts, polyoxyethylene alkyl ether sulfate ester salts, fatty acid monoglyceride sulfate ester salts, polyoxyethylene alkyl phenyl ether sulfate ester salts, polyoxyethylene styrylphenyl ether sulfate ester salts, alkyl phosphate ester salts, polyoxyethylene alkyl ether phosphate ester salts, polyoxyethylene alkyl phenyl ether phosphate ester salts, partial saponification products of styren/maleic anhydride copolymer, partial saponification products of olefin/maleic anhydride copolymer and naphthalene sulfonate formalin condensates.

The cationic surfactant used in the invention is not particularly restricted and those hitherto known can be used. Exanples of the cationic surfactant include alkylamine salts, quaternary ammonium salts, polyoxyethylene alkyl amine salts and polyethylene polyamine derivatives.

The amphoteric surfactant used in the invention is not particularly restricted and those hitherto known can be used. Examples of the amphoteric surfactant include carboxybetaines, aminocarboxylic acids, sulfobetaines, aminosulfuric esters, and imidazolines.

In the surfactants described above, the term “polyoxyethylene” can be replaced with “polyoxyalkyene”, for example, polyoxymethylene, polyoxypropylene or polyoxybutylene, and such surfactants can also be used in the invention.

Further, a preferable surfactant includes a fluorine-based surfactant containing a perfluoroalkyl group in its molecule, Examples of the fluorine-based surfactant include an anionic type, for example, perfluoroalkyl carboxylates, perfluoroalkyl sulfonates or perfluoroalkylphosphates; an amphotetic type, for example, perfluoroalkyl betaines; a cationic type, for example, perfluoroalkyl trimethyl ammonium salts; and a nonionic type, for example, perfluoroalkyl amine oxides, perfluoralkyl ethylene oxide adducts, oligomers having a perfluoroalkyl group and a hydrophilic group, oligomers having a perfluoroalkyl group and an oleophilic group, oligomers having a perfluoroalkyl group, a hydrophilic group and an oleophilic group or urethanes having a perfluoroalkyl group and an oleophilic group. Further, fluorine-based surfctants described in JP-A-62-170950, JP-A-62-226143 and JP-A-60-168144 are also preferably exemplified.

The surfactants can be used individually or in combination of two or more thereof.

The content of the surfactant is preferably from 0.001 to 10% by weight, more preferably from 0.01 to 5% by weight, based on the total solid content of the image-recording layer.

### <Coloring Agent>

To the image-recording layer according to the invention, various compounds other than the compounds described above may further be added, if desired. For instance, a dye having a lamge absorption in the visible region can be used as the coloring agent of the image. Specifically, the dye includes Oil yellow #101, Oil yellow #103, Oil pink #312, Oil green BG, Oil blue BOS, Oil blue #603, Oil black BY, Oil black BS, Oil black T-505 (produced by Orient Chemical Industies, Ltd.), Victoria pure blue, Crystal violet (CI42555), Methyl violet (CI42535), Ethyl violet, Rhodamine B (CI45170B), Malachite green (CI42000), Methylene blue (CI52015) and dyes described in JP-A-62-293247. Further, a pigment, for example, a phthalocyanine pigment, an azo pigment, carbon black or titaniun oxide can also preferably be used.

It is preferred to add the coloring agent since distinction between the image area and the non-image area is easily conducted after the formation of image. The amount of the coloring agent added is preferably from 0.01 to 10% by weight based on the total solid content of the image-recording layer.

### <Print-Out Agent>

To the image-recording layer according to the invention, a compound causing discoloration by an acid or a radical can be added in order to form a print-out image. As such a compound, various kinds of dyes, for example, dyes of diphenylmethane type, triphenylmethane type, tiazine type, oxazine type, xanthene type, anthraquinone type, iminoquinone tpe, azo type and azomethine type are effectively used.

Specific examples thereof include dyes, for example, Brilliant green, Ethyl violet, Methyl green, Crystal violet, basic Fuchsine, Methyl violet 2B, Quinaldine red, Rose Bengal, Methanyl yellow, Thimiol sulfophthalein, Xylenol blue, Methyl orange, Paramethyl red, Congo red, Benzo purpurin 4B, α-Naphthyl red, Nile blue 2B, Nile blue A, Methyl violet, Malachite green, Parafuchsine, Victoria pure blue BOH (produced by Hodogaya Chemical Co., Ltd.), Oil blue #603 (produced by Orient Chemical Industies, Ltd.), Oil pink #312 (produced by Orient Chemical Industries, Ltd.), Oil red 5B (produced by Orient Chemical Industies, Ltd.), Oil scarlet #308 produced by Orient Chemical Industries, Ltd.), Oil red OG (produced by Orient Chemical Industries, Lt&), Oil red RR (produced by Orient Chemical Industies, Ltd.), Oil green #502 (produced by Orient Chemical Industies, Ltd.), Spiron Red BEH special (produced by Hodogaya Chemical Co., Ltd.), m-Cresol purple, Cresol red, Rhodamine B, Rhodamine 6G, Sulfo rhodamine B, Auramine, 4-p-diethylaminophenyliminonaphthoquione, 2-carboxyanilino-4-p-diethyaminophenyliminonaphtoquinone, 2-carboxystearylamino-4-p-N,N-bis(hydroxyethyl)aminophenyliminonahthoquinone, 1-phenyl-3-methyl-4-p-diethylaminophenylimino-5-pyrazolon or 1-β-naphtyl-4-p-diethylaminophenylimino-5-pyrazolon, and a leuco dye, for example, p, p′, p″-hexamethyltriaminotriphenylmethane (leuco crystal violet) or Pergascript Blue SRB (roduced by Ciba Geigy Ltd.).

In addition to those described above, a leuco dye known as a material for heat-sensitive paper or pressure-senitve paper is also preferably used. Specific examples thereof include crystal violet lactone, the green lactone, benzoyl leuco methylene blue, 2-(N-phenyl-N-methylamino)-6-(N-p-tolyl-N-ethyl)aminofluoran, 2-anilino-3-methyl-6-(n-ethyl-p-tolidino)fluoran, 3,6-dimethoxyfluoran, 3-(N,N-diethylamino)-5-methyl-7-(N,N-dibenzylamino)fluoran, 3-(N-cyclohexyl-N-methylamino)-6-methyl-7-anilinofluoran, 3-(N,N-diethylamino)-6-methyl-7-anilinofluoran, 3-(N,N-diethylamino)-6-methyl-7-xyidinofluoran, 3-(N,N-diethylamino)-6-methyl-7chlorofluoran, 3-(N,N-diethylamino)-6-methoxy-7-aminofluoran, 3-(N,N-diethylanino)-7-(4-chloroanilino)fluoran, 3-(N,N-diethylamino)-7-chlorofluoran, 3-(N,N-diethylamino)-7-benzylaminofluoran, 3-(N,N-diethylamino)-7,8-benzofluoran, 3-(N,N-butylamino)-6-methyl-7-anilinofluoran, 3-(N,N-dibutylamino)-6-methyl-7-xylidinofluoran, 3-pipelidino-6-methyl-7-anilinofluoran, 3-pyrolidino-6-methyl-7-anilinofluoran, 3,3-bis(1-ethyl-2-methylindol-3-yl)phthalide, 3,3-bis(1-n-butyl-2-methylindol-3-yl)phtalide, 3,3-bis(p-dimethylaminophenyl)-6-dimethylaminophthalide, 3-(4diethylamino-2-ethoxyphenyl)-3-(1-ethyl-2-methylindol-3-yl)-4-phthalide and 3-(4-diethylaminophenyl)-3-(1-ethyl-2-methylindol-3-yl)phthalide.

The dye discolored by an acid or radical is preferably added in an amount of 0.01 to 10% by weight based on the solid content of the image-recording layer.

### <Polymerization Inhibitor>

It is preferred to add a small amount of a thermal polymerization inhibitor to the image-recording layer according to the invention in order to inhibit undesirable thermal polymerization of the polymerizable compound (C) during the production or preservation of the image-recording layer.

The thermal polymerization inhibitor preferably includes, for example, hydroquinone, p-methoxyphenol, di-tert-butyl-p-cresol, pyrogallol, tert-butyl catechol, benzoquinone, 4,4′-thiobis(3-methyl-6-tert-butylphenol), 2,2′-methylenebis(4-methyl-6-tert-butylphenol) and N-nitroso-N-phenylhydroxylamine aluminum salt.

The amount of the thermal polymerization inhibitor added is preferably from about 0.01 to about 5% by weight based on the total solid content of the image-recording layer.

### Higher Fatty Acid Derivative>

To the image-recording layer according to the invention, a higher fatty acid derivative, for example, behenic acid or behenic acid amide may be added to localize on the surface of the image-recording layer during a drying step after coating in order to avoid polymerization inhibition due to oxygen. The amount of the higher fatty acid derivative added is preferably from about 0.1 to about 10% by weight based on the total solid content of the image-recording layer.

### <Plasticizer>

The image-recording layer according to the invention may contain a plasticizer in order to improve the on-machine development property. The plasticizer preferably includes, for example, a phthalic acid ester, e,g., diemthylphthalate, diethylphthalate, dibutylphthalate, dibutylphthalate, dioctylphthalate, octylcaprylphthalate, dicyclohexylphthalate, ditridecylphthalate, butylbenzylphthalate, diisodecylphthalate or diallylphthalate; a glycol ester, e.g., dimethylglycolphthalate, ehtylphtalylethylglycolate, methylphthalylethylglycolate, butylphthalyibutylglycolate or triethylene glycol dicaprylate ester, a phosphoric acid ester, e.g., tricresylphosphate or triphenylphosphate; an aliphatic dibasic acid ester, e.g., diisobutyladipate, dioctyladipate, dimethylsebacate, dibutylsebacate, dioctylazelate or dibutyimaleate; polyglycidylmethacrylate, triethyl citrate, glycerin triacetyl ester and butyl laurate.

The content of the plasticizer is preferably about 30% by weight or less based on the total solid content of the image-recording layer.

### <Fine Inorganic Particle>

The image-recording layer according to the invention may contain fine inorganic particle in order to increase the strngth of the cured ifim in the image area and to improve the on-machine development property in the non-image area.

The fine inorgaric particle preferably includes, for example, silica, alumina, magnesium oxide, titanium oxide, magnesium carbonate, calcium alginate and a mix thereof. The fine inorganic particle can be used, for example, for strengthening the film or enhancing the interface adhesion property due to surface roughening, even when it has not light-to-heat conversion property.

The fine inorganic particle preferably has an average particle size from 5 nm to 10 μm and more preferably from 0.5 to 3 μm. In the above-described range, it is stably dispersed in the image-recording layer, sufficiently maintains the film strength of the image-recording layer and can form the non-image area excellent in hydrophilicity and prevented from stain during printing.

The fine inorganic particle described above is easily available as a commercial product, for example, colloidal silica dispersion.

The content of the fine inorganic particle is preferably 40% by weight or less and more preferably 30% by weight or less based on the total solid content of the image-recording layer.

### <Hydrophilic Low Molecular Weight Compound>

The image-recording layer according to the invention may contain a hydrophilic low molecular weight compound in order to improve the on-machine development property. The hydrophilic low molecular weight compound includes a water soluble organic compound, for example, a glycol e.g., ethylene glycol, diethylene glycol, triethylene glycol propylene glycol, dipropylene glycol or tripropylene glycol, or an ether or ester derivative thereof, a polyhydroxy compound, e.g., glycerine or pentaerythritol, an organic amine compound, e.g., triethanol amine, diethanol amine or monoethanol amine, or a salt thereof, an organic sulfonic acid compound, e.g., toluene sulfonic acid or benzene sulfonic acid, or a salt thereof, an organic phosphonic acid compound, e.g., phenyl phosphonic acid, or a salt thereof, an organic carboxylic acid, e.g., tanaric acid, oxalic acid, citric acid, malic acid, lactic acid, gluconic acid or an amino acid, or a salt thereof.

### <Formation of Image-Recording Layer>

The image-recording layer according to the invention is formed by dispersing or dissolving each of the necessary constituting components described above in a solvent to prepate a coating solution and coating the solution. The solvent used include, for example, ethylene dichloride, cyclohexanone, methyl ethyl ketone, methanol, ethanol, propanol ethylene glycol monomethyl ether, 1-methoxy-2-propanol, 2-methxyethyl acetate, 1-methoxy-2-propyl acetate, dimethoxyethane, methyl lactate, ethyl lactate, N,N-dimethylacetoamide, N,N-dimethylformamide, tetramethylurea, N-methylpyrrolidone, dimethylsulfoxide, sulfolane, γ-butyrolactone, toluene and water, but the invention should not be construed as being limited thereto. The solvents may be used individually or as a mixture. The solid content concentration of the coating solution is preferably from 1 to 50% by weight.

The image-recording layer according to the invention may also be formed by prqpamg plural coating solutions by dispersing or dissolving the same or different components described above into the same or dfferent solvents and conducting repeatedly the coating and drying plural times.

The coating amount of the image-recording layer (solid content) formed on a sort after drying may be varied according to the intended purpose but is preferably from 0.3 to 3.0 g/m². In the above-described range, good sensitivity and good film property of the image-recording layer can be achieved.

Various methods can be used for the coating. Examples of the coating method include bar coater coating, spin coating, spray coating, curtain coating, dip coating, air knife coating, blade coating and roll coating.

### [Support]

A support for use in the lithographic printing plate precursor according to the invention is not particularly restricted as long as it is a dimensionally stable plate-like material. The support includes, for example, paper, paper laminated with plastic (for example, polyethylene, polypropylene or polystyrene), a metal plate (for example, aluminum, zinc or copper plate), a plastic film (for example, cellulose diacetain, cellulose triacetate, cellulose propionate, cellulose butyrate, cellulose acetate butyrate, cellulose nitrate, polyethylene terephtalate, polyethylene, polystyrene, polypropylene, polycarbonate or polyvinyl acetal film) and paper or a plastic fMim laminated or deposited with the metal described above. A prefered support includes a polyester film and an aluminum plate. Among them, the aluminum plate is preferred since it has good dimensional stability and is relatively inexpensive.

The aluminum plate includes a pure aluminum plate, an alloy plate comprising aluminum as a main component and containing a trace amount of hetero elements and a thin fllm of aluminum or aluminum alloy laminated with plastic. The hetero element contained in the aluminum alloy includes, for example, silicon, iron, manganese, copper, magnesium chromium, zinc, bismuth, nickel and titanium. The content of the hetero elemtet in the aluminum alloy is preferably 10% by weight or less. Although a pure aluminum plate is preferred in the invention, since completely pure aluminum is difficult to be produced in view of the refining technique, the aluminum plate may slightly contain the hetero element. The composition is not specified for the aluminum plate and those materials conventionally known and used can be appropriately utilized.

The thickness of the support is preferably from 0.1 to 0.6 mm, and more preferably from 0.15 to 0.4 mm.

In advance of the use of aluminum plate, a surface treatment, for example, roughening treatment or anodizing treatment is preferably performed. The surface treatment facilitates jiprovement in the hydrophilic property and ensure for adhesion between the image-recording layer and the support. Prior to the roughening treatment of the aluminum plate, a defreasing treatment, for example, with a surfactant, an organic solvent or an aqueous alkaline solution is conducted for removing rolling oil on the surface thereof if desired.

The roughening treatment of the surface of the aluminwn plate is conducted by various methods and includes, for example, mechanical roughening treatment, electrochemical roughening treatment (roughening treatment of electrochemically dissolving the surface) and chemical roughening treatment (roughening treatment of chemically dissolving the surface selectively).

As the method of the mechanical roughening treatment, a known method, for example, ball grainig, brush graining, blast graining or buff graining can be used. Also, a transfer method can be employed wherein using a roll having concavo-convex shape the concavo-convex shape is transferred to the surface of aluminum plate during a rolling step of aluminum plate.

The electochemical roughening treatment method includes, for example, a method of conducting by passng alternating current or direct current in an electrolyte containing an acid, for example, hydrochloric acid or nitric acid. Also, a method of using a mixed acid described in JP-A-54-63902 can be exemplified.

The aluminum plate subjected to the roughening treatent is subjected, if desired, to an alkali etching treatment using an aqueous solution, for example, of potassium hydroxide or sodium hydroxide and further subjected to a neutrlizing treatent, and then subjected to an anodizing treatment for improving the abrasion resistance, if desired.

As the electrolyte used for the anodizing treatment of the aluminum plate, various electrolytes capable of forming porous oxide film can be used. Ordinarily, sulfuric acid, hydrochloric acid, oxalic acid, chromic acid or a mixed acid thereof is used. The concentration of the electrolyte can be appropriately determined depending on the kind of the electrolyte.

Since the conditions for the anodizing treatment are varied depending on the electrolyte used, they cannot be defined commonly. However, it is ordinarily preferred that electrolyte concentration in the solution is from 1 to 80% by weight, liquid temperature is from 5 to 70° C., current density is 5 to 60 A/dm², voltage is from 1 to 100 V, and electrolysis time is from 10 seconds to 5 minutes. The amount of the anodized film formed is preferably from 1.0 to 5.0 g/m² and more preferably from 1.5 to 4.0 g/m². In the above-described range, good printing durability and good scratch resistance in the non-image area of lithographic printing plate can be achieved.

The aluminum plate subjected to the surface treatment and having the anodized film is used as it is as the support in the invention. However, in order to more improve the adhesion prperty to a layer provided thereon, hydrophilicity, stain resistance, heat insulating property or the like, other treatment, for example, a treatment for enlarging micropores or a sealing treatment of micropores of the anodized film described in JP-A-2001-253181 and JP-A-2001-322365, or a surface hydrophilizing treatment by immersing in an aqueous solution containing a hydrophilic compound may be appropriately conducted. Needless to say, the enlarging treatment and sealing treatment are not limited to those described in the above-described patents and any conventionally known method may be employed. For instance, as the sealing treatment, as well as a sealing treatment with steam, a sealing treatment with fluorozirconic acid alone, a sealing treatment with sodium fluoride or a sealing treatment with steam having added thereto lithium chloride may be employed.

The sealing treatment for use in the invention is not particularly limited and conventionally known methods can be employed. Among them, a sealing treatment with an aqueous solution containing an inorganic fluorine compound, a sealing treatment with water vapor and a scaling treatment with hot water are preferred. The sealing treatment is described in more detail below.

### <1>Sealing Treatment With Aqueous Solution Containing Inorganic Fluorine Compound

As the inorganic fluorine compound used in the sealing treatment with an aqueous solution containing an inorganic fluorine compound, a metal fluoride is preferably exemplified.

Specific examples thereof include sodium fluoride, potassium fluoride, calcium fluoride, magnesium fluoride, sodium fluorozirconate, potassium fluorozirconate, sodium fluorotitanate, potassium fluorotitanate, ammonium fluorozirconate, ammonium fluorotitanate, potassium fluorotitanate fluorozirconic acid, fluorotitanic acid, hexafluorosilicic acid, nickel fluoride, iron fluoride, fluorophosphoric acid and ammonium fluorophosphate. Among them, sodium fluorozirconate, sodium fluorotitinate, fluorozirconic acid and fluorotitanic acid are preferred.

The concentration of the inorganic fluorine compound in the aqueous solution is preferably 0.01% by weight or more, more preferably 0.05% by weight or more, in view of satisfactory sealing of micropores of the anodized film, and it is preferably 1% by weight or less, more preferably 0.5% by weight or less in view of stain resistance.

The aqueous solution containing an inorgaic fluorine compound preferably further contains a phosphate compound. When the phosphate compound is contained, the hydrophilicity on the anodized film surface is increard and thus, the on-machine development property and stain resistance can be improved.

Preferable examples of the phosphate compound include phosphates of metal, for example, an alkali metal or an alkaline earth metal.

Specfic examples of the phosphate compound include zinc phosphate, aluminum phosphate, ammonium phosphate, diammonium hydrogen phosphate, ammonium dihydrogen phosphate, monoammonium phosphate, monopotassium phosphate, monosodium phosphate, potassium dihydrogen phosphate, dipotassium hydrogen phosphate, calcium phosphate, sodium ammonium hydrogen phosphate, magnesium hydrogen phosphate, magnesium phosphate, ferrous phosphate, feric phosphate, sodium dihydrogen phosphate, sodium phosphate, disodium hydrogen phosphate, lead phosphate, diammonium phosphate, calcium dihydrogen phosphate, lithium phosphate, phosphotungstic acid, ammonium phosphotungstate, sodium phosphotungstate, ammonium phosphomolybdate, sodium phosphomolybdate, sodium phosphite, sodium tripolyphosphate and sodium pyrophosphate. Among them, sodium dihydrogen phosphate, disodium hydrogen phosphate, potassium dihydrogen phosphate and dipotassium hydrogen phosphate are preferred.

The combination of the inorganic fluorine compound and the phosphate compound is not particularly limited, but it is prefer ftat the aqueous solution contains at least sodium fluorozirconate as the inorganic fluorine compound and at least sodium dihydrogen phosphate as the phosphate compound.

The concentration of the phosphate compound in the aqueous solution is preferably 0.01% by weight or more, more preferably 0.1% by weight or more, in view of improvement in the on-machine development property and stain resistance, and it is preferably 20% by weight or less, more preferably 5% by weight or less, in view of solubility.

The ratio of respective compounds in the aqueous solution is not particularly limited, and the weight ratio between the inorganic fluorine compound and the phosphate compound is preferably from 1/200 to 10/1, more preferably from 1/30 to 2/1.

The temperature of the aqueous solution is preferably 20° C. or more, more preferably 40° C. or more, and it is preferably 100° C. or less, more preferably 80° C. or less.

The pH of the aqueous solution is preferably 1 or more, more preferably 2 or more, and it is preferably 11 or less, more preferably 5 or less.

A method of the sealing treatment with the aqueous solution containing an inorganic fluorine compound is not particularly limited, and examples thereof include a dipping method and a spray method. One of the treatments may be used alone once or multiple times, or two or more thereof may be used in combination.

In particular, a dipping method is preferred. In the case of performing the treatment using the dipping method, the treating time is preferably one second or more, more preferably 3 seconds or more, and it is preferably 100 seconds or less, more preferably 20 seconds or less.

### <Sealing Treatment With Water Vapor

Examples of the sealing treatment with water vapor include a method of continuously or discontinuously bringing water vapor under applied pressure or normal pressure into contact with the anodized film.

The temperature of the water vapor is preferably 80° C. or more, more preferably 95° C. or more, and it is preferably 105° C. or less.

The pressure of the water vapor is preferably in a range from (atmospheric pressure—50 mmAq) to (atmospheric pressure+300 mmAq) (from 1.008×10⁵ to 1.043×10⁵ Pa).

The time period for which water vapor is contacted is preferably one second or more, more preferably 3 seconds or more, and it is preferably 100 seconds or less, more preferably 20 seconds or less.

### <3>Sealing Treatment With Hot Water

Examples of the sealing treatment with hot water include a method of dipping the aluminum plate having formed thereon the anodized film in hot water.

The hot water may contain an inorganic salt (for example, a phosphate) or an organic salt.

The temperature of the hot water is preferably 80° C. or more, more preferably 95° C. or more, and it is preferably 100° C. or less.

The time period for which the aluminum plate is dipped in hot water is preferably one second or more, more preferably 3 seconds or more, and it is preferably 100 seconds or less, more preferably 20 seconds or less.

The hydrophilizing treatment describe above includes an alkali metal silicate method described in U.S. Pat. Nos. 2,714,066, 3,181,461, 3,280,734 and 3,902,734. In the method, the support is subjected to immersion treatment or electrolytic treatment in an aqueous solution containing, for example, sodium silicate. In addition, the hydrophilizing treatment includes, for example, a method of treating with potassium fluorozirconate described in JP-B-36-22063 and a method of treating with polyvinylphosphonic acid described in U.S. Pat. Nos. 3,276,868, 4,153,461, and 4,689,272.

In the case of using a support having a surface of insufficient hydrophilicity, for example, a polyester film in the invention, it is desirable to apply a hydrophilic layer thereon to make the surface sufficiently hydrophilic. The hydrophilic layer preferably includes a hydrophilic layer formed by applying a coating solution containing a colloid of an oxide or hydroxide of at leat one element selected from beryllium, magnesium, aluminun, silicon, titanium boron, germanium, tin, zirconium, iron, vanadium, antimony and a transition metal described in JP-A-2001-199175, a hydrophilic layer containing an organic hydrophilic matrix obtained by crosslinking or pseudo-crosslinking of an organic hydrophilic polymer described in JP-A-2002-79772, a hydrophilic layer containing an inornanic hydrophilic matrix obtained by sol-gel conversion comprising hydrolysis and condensation reaction of polyalkoxysilane and titanate, zirconate or aluminate and a hydrophilic layer comprising an inorganic thin layer having a surface containing a metal oxide. Among them, the hydrophilic layer formed by applying a coating solution containing a colloid of an oxide or hydroxide of silicon is preferred.

Further, in the case of using, for example, a polyester film as the support in the invention, it is preferred to provide an antistatic layer on the hydrophilic layer side, opposite side to the hydrophilic layer or both sides. When the antistatic layer is provided between the support and the hydrophilic layer, it also contributes to improve the adhesion of the hydrophilic layer to the support. As the antisatic layer, a polymer layer having fine particles of metal oxide or a mating agent dispersed therein described in JP-A-2002-79772 can be used.

The support preferably has a center line average roughness of 0.10 to 1.2 μm. In the above-described range, good adhesion property to the image-recording layer, good priming durability and good stain resistance can be achieved.

### [Backcoat Layer]

After applying the surface treatment to the support or forming an undercoat layer described hereinafter on the support, a backcoat layer can be provided on the back surface of the support if desired.

The backcoat layer preferably includes, for example, a coating layer comprising an organic polymer compound described in JP-A-545885 and a coating layer comprising a metal oxide obtained by hydrolysis and polycondensation of an organic metal compound or an inorganic metal compound described in JP-A-34174. Among them, use of an alkoxy compound of silicon, for example, Si(OCH₃)₄, Si(OC₂H₅)₄, Si(OC₃H₇)₄ or Si(OC₄H₉)₄ is preferred since the starting material is inexpensive and easily available.

### [Undermoat Layer]

In the lithographic printing plate precursor according to the invention, particularly in the lithographic priming plate precursor of on-machine development type, an undercoat layer is provided between the support and the image-recording layer, if desired. The undercoat layer makes removal of the image-recording layer from the support in the unexposed area easy so that the on-machine development property can be improved. Further, it is advantageous that in the case of infrared laser exposure, since the undercoat layer acts as a heat insulaling layer, heat generated upon the exposure does not diffuse into the support and is efficiently utilized so that increase in sensitivity can be achieved.

As a compound (undercoat compound) for the undercoat layer, specifically, for example, a silane coupling agent having an addition-polymaizable ethylenic double bond reactive group described in JP-A-10-282679 and a phosphorus compound having an ethylenic double bond reactive group described in JP-A-2-304441 are preferably exemplified.

As the most preferable compound for undercoat layer, a polymer resin obtained by copolymerization of a monomer having an adsorbing group, a monomer having a hydrophilic group and a monomer having a polymerizable reactive group (crosslinkable group) is exemplified.

The essential component in the polymer resin for undercoating is an adsorbing group to the hydrophilic surface of the support. Whether adsorptivity to the hydrophilic surface of the support is present or not can be judged, for example, by the following method.

A test compound is dissolved in an easily soluble solvent to prepare a coating solution, and the coating solution is applied and dried on a support so as to have the coating amount after drying of 30 mg/m². After thoroughly washing the support coated with the test compound using the easily soluble solvent, the residual amount of the test compound that has not been removed by the washing is measured to calculate the adsorption amount to the support. For measuring the residual amount, the residual amount of the test compound may be directly determined, or may be calculated by determining the amount of the test compound dissolved in the washing solution. The determination for the compound can be performed, for example, by X-ray fluorescence spectrometry measurement reflection absorption spectrometry measurement or liquid chromatography measurement. The compound having the adsorptivity to support is a compound that remains by 1 mg/m² or more even after conducting the washing treatment described above.

The adsorbing group to the hydrophilic surface of the support is a functional group capable of forming a chemical bond (for example, an ionic bond, a hydrogen bond, a coordinate bond or a bond with intermolecular force) with a substance (for example, metal or metal oxide) or a functional group (for example, a hydroxy group) present on the surface of the support. The adsorbing group is preferably an acid group or a cationic group.

The acid group preferably has an acid dissociation constant (pKa) of 7 or less. Examples of the acid group include a phenolic hydroxy group, a carboxyl group, —SO₃H, —OSO₃H, —PO₃H₂, —OPO₃H₂, —CONHSC₂—, —SO₂NHSO₂— and —COCH₂COCH₃. Among them, —OPO₃H₂ and —PO₃H₂ are particularly preferred. The acid group may be the form of a metal salt.

The cationic group is preferably an onium group. Examples of the onium group include an ammonium group, a phosphonium group, an arsonium group, a stibonium group, an oxonium group, a sulfonium group, a selenonium group, a stannonium group and iodonium group. Among them, the ammonium group, phosphonium group and sulfonium group are preferred, the ammonium group and phosphonium group are more preferred, and the ammonium group is most preferred.

Particularly preferable examples of the monomer having the adsorbing group include compounds represented by the following formula (I) or (II):

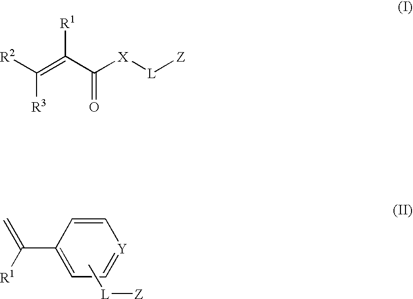

In the above forula R¹, R² and R³ each independently represents a hydrogen atom, halogen atom or an alkyl group having from 1 to 6 carbon atoms. R¹, R² and R³ each independently represents preferably a hydrogen atom or an alkyl group having from 1 to 6 carbon atoms, more preferably a hydrogen atom or an alkyl group having from 1 to 3 carbon atoms and, most preferably a hydrogen atom or methyl. It is particularly preferred that R² and R³ each represents a hydrogen atom. Z represents a functional group adsorbing to the hydrophilic surface of the support.

In formula (I), X represents an oxygen atom (—O—) or imino group (—NH—). Preferably, X represents an oxygen atom.

In the formula (I), L represents a divalent connecting group. It is prefered that L represents a divalent aliphatic group (for example, an alkylene group, a substituted alkylene group, an alkenylene group, a substituted alkenylene group, an alkinylene group or a substituted alkinylene group), a divalent aromatic group (for example an arylene group or a substituted arylene group), a divalent heterocyclic group or a combination of each of the groups described above with an oxygen atom (—O—), a sulfur atom (—S—), an imino group (—NH—), a substituted imino group (—NR—, where R represents an aliphatic group, an aromatic group or a heterocyclic group) or a carbonyl group (—CO—).

The aliphatic group may form a cyclic structure or a branched stucture. The number of caron atoms of the aliphatic group is preferably from 1 to 20, more preferably from 1 to 15, and most preferably from 1 to 10. It is preferred that the aliphatic group is a saturated aliphatic group rather than an unsaturated aliphatic group. The aliphatic group may have a substituent. Examples of the substituent include a halogen atom, a hydroxy group, an aromatic group and a hetrocyclic group.

The number of carbon atoms of the aromatic group is preferably from 6 to 20, more preferably from 6 to 15 and most preferably from 6 to 10. The aromatic group may have a substituent. Examples of the substituent include a halogen atom, a hydroxy group, an aliphatic group, an aromatic group and a heterocyclic group.

It is preferred that the heterocyclic group has a 5-membered or 6-membered ring as the hetero ring. Other heterocyclic ring, an aliphatic ring or an aromatic ring may be condensed to the heterocyclic ring. The heterocyclic group may have a substituent. Examples of the substituent include a halogen atom, a hydroxy group, an oxo group (═O), a thioxo group (═S), an imino group (═NH), a substituted imino group (═N—R, where R represents an aliphatic group, an aromatic group or a heterocyclic group), an aliphatic group, an aromatic group and a heterocyclic group.

It is preferred that L represents a divalent connecting group containing a plurality of polyoxyalkylene structures. It is more preferred that the polyoxyalkylene structure is a polyoxyethylene sue. Specifically, it is preferred that L contains —(OCH₂CH₂)ₙ— (n is an integer of 2 or more),

In formula (II), Y represents a carbon atom or a nitrogen atom. In the case where Y is a nitrogen atom and L is connected to Y to form a quatenary pyridinium group, Z is not mandatory and may represents a hydrogen atom because the quaternary pyridinium group itself exhibits the adsorptivity. L represents a divalent connecting group same as in formula (I) or a single bond.

The adsorbing functional group includes those described above.

Representative examples of the compound represented by formula (I) or (II) are set forth below.

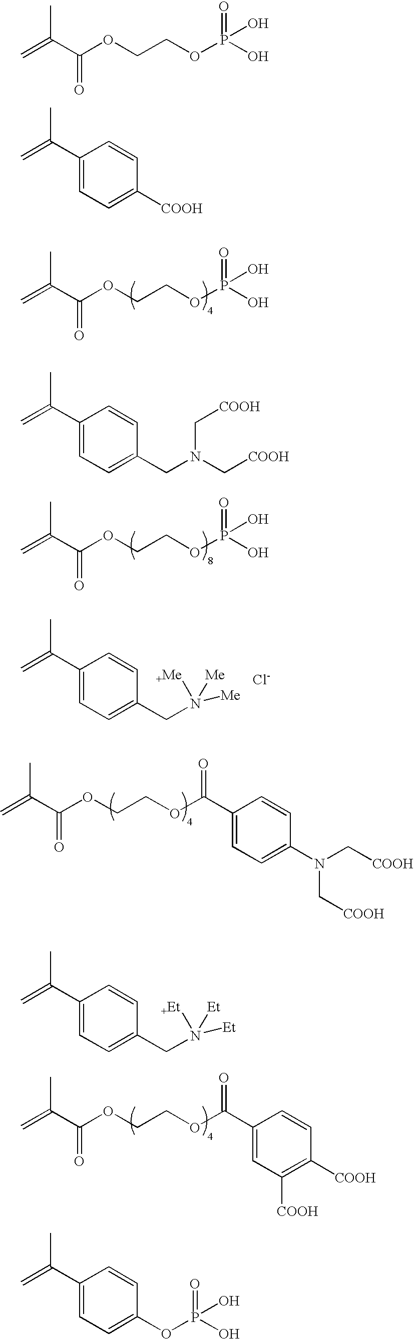

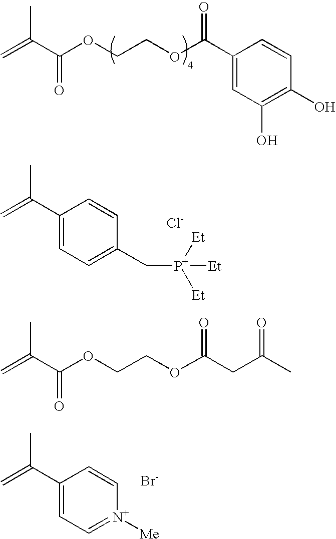

The hydrophilic group included in the polymer resin for the undercoat layer for use in the invention preferably includes, for example, a hydroxy group, a carboxyl group, a carboxylate gropp, a hydroxyethyl group, a polyoxyethyl group, a hydroxypropyl group, a polyoxypropyl group, an amino group, an aminoethyl group, an aminopropyl group, an ammonium group, an amido group, a carboxymethyl group, a sulfonic acid group and a phosphoric acid group. Among them, a sulfonic acid group exhibiting a highly hydrophilic property is preferable. Specific examples of the monomer having a sulfonic acid group include a sodium salt or an amine salt of methallyloxybenzenesulfonic acid, alkyloxybenzenesulfonic acid, alkylsulfonic acid, vinylsulfonic acid, p-styrenesulfonic acid, methalkylsulfonic acid, acrylamido-tert-butylsulfonic acid, 2-acrylamido-2-nethylpropanesulfonic acid or (3-acryloyloxypropyl)buthylsulfonic acid. Among them, from the standpoint of the hydrophilic property and handling property in the synthesis thereof; sodium salt of 2-acrylamido-2-methylpropanesulforic acid is preferable.

It is preferred that the water-soluble polymer resin for the undercoat layer according to the invention has a polymerizable reactive group. The polymerizable reactive group acts to improve the adhesion to the image area. In order to impart the crosslinking property to the polymer resin for the underoat layer, introduction of a crosslinkable functional group, for example, an ethylenically unsaturated bond into the side chain of the polymer or introduction by formation of a salt structure between a polar substituent of the polymer resin and a compound contaning a substituent having a counter charge to the polar substituent of the polymer resin and an ethylenically unsatimited bond is used.

Examples of the monomer for introducing the ethylenically unsaturated bond into the side chain of the polymer include a monomer of an ester or amide of acrylic acid or methacrylic acid, which is a monomer wherein the ester or amide residue (R in —COOR or —CONHR) has the ethylenically unsaturated bond.

Examples of the residue (R described above) having an ethylenically unsaturated bond include —(CH₂)ₙCR₁═CR₂R₃, —(CH₂O)ₙCH₂CR₁═—CR₃R₃, —(CH₂CH₂O)ₙCH₂CR₁═CR₂R₃, —(CH₂)ₙNH—CO—O—CH₂CR₁═CR₂R₃, —(CH₂)ₙ—O—CO—CR₁═CR₂R₃ and —CH₂CH₂O)₂—X (wherein R₁ to R₃ each represents a hydrogen atom, a halogen atom or an alkyl group having from 1 to 20 carbon atoms, an aryl group, alkoxy group or aryloxy group, or R₁ and R₂ or R₁ and R₃ may be combined with each other to fon a ring. n represents an integer of 1 to 10. X represents a dicyclopentadienyl residue).

Specific examples of the ester residue include —CH₂CH═CH₂ (described in JP-B-7-21633) —CH₂CH₂O—CH₂CH═CH₂, —CH₂C(CH₃)═CH₂, —CH₂CH═CH—C₆H₅, —CH₂CH₂OCOCH═CH—C₆H₅, —CH₂CH₂—NHCOO—CH₂CH═CH₂ and —CH₂CH₂O—X (wherein X represents a dicyclopentadienyl residue).

Specific examples of the amide residue include —CH₂CH═CH₂, —CH₂CH₂O—Y (wherein Y represents a cyclohexene residue) and —CH₂CH₂OCO—CH═CH₂.

The content of the polymerizable reactive group in the polymer resin for undercoat layer (content of the radical polymerizable unsaturated double bond determined by iodine titration) is preferably from 0.1 to 10.0 mnmol, more preferably from 1.0 to 7.0 mmol and most preferably from 2.0 to 5.5 mmol based on 1 g of the polymer resin. In the above-described range, preferable compatibility between the sensitivity and stain resistance and good preservation stability can be achieved.

The weight average molecular weight of the polymer resin for undercoat layer is preferably 5,000 or more, more preferably from 10,000 to 300,000. The number averge molecular weight of the polymer resin is preferably 1,000 or more, more preferably from 2,000 to 250,000. The polydispersity (weight average molecular weight/number average molecular weight) thereof is preferably from 1.1 to 10.

The polymer resin for undecoat layer may be any of a random polymer, a block polymer, a gft polymer and the like, and is preferably a random polymer.

The polymer resins for undercoat layer may be used individually or in a mixture of two or more thereof. A coating solution for undercoat layer is obtained by dissolving the polymer resin for undercoat layer in an organic solvent (for example, methanol, ethanol, acetone or methyl ethyl ketone) and/or water. The coating solution for undercoat layer may contain an infrared absorbing agent.

In order to apply the coating solution for undercoat layer on the support various methods can be used. Examples of the method include bar coater coating, spin coating, spray coaling, curtain coating, dip coating, air knife coating, blade coating and roll coating.

The coating amount (solid content) of the undercoat layer is preferably from 0.1 to 100 mg/m², and more preferably from 1 to 30 mg/m².

### [Lithographic Printing Method]

According to lte invention, the lithographic printing plate cursor of the invention described above is exposed imagewise with a laser. The laser for use in the invention is not particularly restricted and, for exammple, a solid laser or semiconductor laser emitting an infrared ray having a wavelength of 760 to 1,200 nm is preferably exemplified. The output of the infrared laser is preferably 100 mW or more. Further, in order to shorten the exposure time, it is preferred to use a multibeam laser device.

The exposure time per pixel is preferably within 20 microseconds, and the irradiaton energy is preferably from 10 to 300 mJ/cm².

As the aqueous component making the unexposed area of the image-recording layer of the lithographic printing plate precursor removable, a solution containing a variety of compounds dissolved or dispersed in water is exemplfiied. The compound dissolved or dispersed in water preferably includes a polar solvent, for example, an alcohol, a surfactant, an organic acid or a salt thereof and an inorganic acid or a salt thereof. The removal of the unexposed area of the image-recording layer may be conducted in a developing machine or on a printing machine.

Examples of the alcohol include methanol, ethanol, propanol, isopropanol benzyl alcohol, ethylene glycol, ethylene glycol monomethyl ether, 2-ethyoxyethanol, diethylene glycol monoethyl ether, diethylene glycol monohexyl ether, triethylene glycol monomethyl ether, propylene glycol propylene glycol monomethyl ether, polyethylene glycol monoethyl ether, polypropylene glycol mono-n-butyl etherpolypropylene glycol mono-n-propyl ether, dipropylene glycol monomethyl ether, octanediol, polyethylene glycol monomethyl ether, polypropylene glycol, tetraethylene glycol or glycerol.

Among them, isopropanol benzyl alcohol, propylene glycol monomethyl ether, polypropylene glycol mono-n-butyl ether, octanediol or glycerol is particularly preferably used.

The content of the alcohol in the aqueous component is preferably from 0.01 to 10% by weight, more preferably from 0.1 to 5% by weight, and most preferably from 0.5 to 3% by weight. In the above-described range, the on-machine development property can be preferably accelerated without accompanying damage on the exposed area of the image-recording layer.

In the case of using an aqueous solution containing the surfactant as the aqueous component, the aqueous component of low foaming property is preferable from the standpoint of avoiding various problems based on the foaming, for example, the occurence of foam between a blanket cleaning member and a blanket surface, the occurrence of foam in a tnk for storing the aqueous component, or load against a feeding pump for supplying the aqueous component to the blanket cleaning member due to introduction of the foams into the feeding pump.

The surfactant is not particularly restricted and, for example, a nonionic surfactant or an anionic surfactant is exemplified.

The nonionic surcant includes, for example, polyethylene glycol type higher alcohol ethylene oxide addacts, alkylphenol ethylene oxide addacts, fatty acid ethylene oxide addacts, polyhydric alcohol fatty acid ester ethylene oxide addacts, higher alkylamine ethylene oxide addacts, fatty acid amide ethylene oxide addacts, ethylene oxide addacts of fat, polypropylene glycol ethylene oxide addacts, dimethylsiloxane-ethylene oxide block copolymers, dimethylsiloxane-(propylene oxide-ethylene oxide) block copolymers, fatty acid esters of polyhydric alcohol type glycerol, fatty acid esters of pentaerythritol, fatty acid esters of sorbitol and sorbitan, fatty acid esters of sucrose, alkyl etier of polyhydric alcohols and fatty acid amides of alkanolamines. The nonionic surfactant may be used individually or as a mixture of two or more thereof.

The HLB (hydrophile-lipophile balance) value of the nonionic surfactant is preferably from 6 to 15, more preferably from 6 to 13, particularly preferably from 6 to 11, from the standpoint of improvements in the stable solubility in water, turbidity and on-machine development property.

The anionic surfactant includes, for example, fatty acid salts, abietic acid salts, hydroxyalkanesulfonic acid salts, alkanesulfonic acid salts, dialkylsulfosuccinic acid salts, straight-chain alkylbenzenesulfonic acid salts, branched alkylbenzenesulfonic acid salts, alkylnapthalenesulfonic acid salt, alkylphenoxypolyoxy ethylene propylsulfonic acid salts, polyoxyethylene alkylsulfophenyl ether salts, N-methyl-N-oleyltaurine sodium salt, N-alkylsulfosuccinic acid monoamnide disodium salts, petroleum sulfonic acid salts, sulfated castor oil, sulfated beef tallow oil sulfate ester slats of fatty acid alkyl ester, alkyl sulfate ester salts, polyoxyethylene alkyl ether sulfide ester salts, fatty acid monoglyceride sulfate ester salts, polyoxyethylene alkyl phenyl ether sulfate ester salts, polyoxyethylene styryl phenyl ether sulfate ester salts, alkyl phosphate ester salts, polyoxyethylene alkyl ether phosphate ester salts, polyoxyethylene alkyl phenyl ether phosphate ester salts, partially saponified products of styrene-maleic anhydride copolymer, partially saponified products of olefin-maleic anhydride copolymer and naphthalene sulfonate formalin condensates.

More specifically, for example, sodiumn dodecylbenzenesulfonate, sodium laurylsulfate, sodium alkyldiphenyl ether disulfonate, sodium alkylnaphthalenesulfonate, sodium dialkylsulfosuccinate, sodium stearate, potassium oleate, sodium dioctylsulfosuccinate, sodium polyoxyethylene alkyl ether sulfate, sodium polyoxyethylene alkyl ether sulfate, sodium polyoxyethylene alkyl phenyl ether sulfate, sodium dialkylsulfosuccinate, sodium stearate, sodium oleate and sodium tert-octylphenoxyethoxypolyethoxyethylsulfate.

Of the compounds, dialkylulfosuccinic acid salts, alkyl sulfate ester salts and alkylnaphtalenesulfonic acid salts are particularly preferably used.

The content of the surfactant in the aqueous component is preferably from 0.01 to 0.20% by weight, more preferably from 0.02 to 0.18% by weight and most preferably from 0.04 to 0.15% by weight. In the above-described range, the on-mahine development property can be preferably accelerated without accompanying deterioration of the stability of the aqueous component and the problems due to the foaming.

Moreover, a known defoarnmg agent may be added to the aqueous component for the purpose of further avoiding the foaming. As the defoaming agent, a silicone type defoaming agent is particularly preferably used. Furthermore, an alkali agent (for example, sodium carbonate, diethanolamine or sodium hydroxide) or an antiseptic agent (for example, benzoic acid or a derivative thereof, sodium dehydroacetne, a 3-isothiazolone compound, 2-bromo-2-nitro-1,3-propanediol or sodium salt of 2-pyridinethiol-1-oxide) may be added to the aqueous component.

The water-soluble polymer compound for use in the aqueous component according to the invention includes, for example, soybean polysaccharide, modified starch, gum arabic, dextrin, a cellulose derivative (for example, carboxymethyl cellulose, carboxyethyl cellulose or methyl cellulose) or a modified product thereof, pllulan, polyvinyl alcohol or a derivative thereof polyvinyl pyrrolidone, polyacrylamide, an acrylamide copolymer, a vinyl methyl ether/maleic anhydride copolymer, a vinyl acetate/maleic anhydride copolymer and a styrene/maleic anhydride copolymer.

As the soybean polysaccharide, those known can be used. For example, as a commercial product, Soyafive (trade name, produced by Fuji Oil Co., Ltd.) is available and various grade product can be used. The soybean polysaccaride preferably used has viscosity in a range of 10 to 100 mPa/sec in a 10% by weight aqueous solution thereof.

As the modified starch, known modified starch can be used. The modified starch can be prepared, for example, by a method wherein starch for example, of corn, potato, tapioca, rice or wheat is decomposed, for example, with an acid or an enzyme to an extent that the number of glucose residue per molecule is from 5 to 30 and then oxypropylene is added thereto in an alkali.

Two or more of the water-soluble polymer compounds may be used in combination. The content of the water-soluble polymer compound in the aqueous component is preferably from 0.1 to 20% by weight, and more preferably from 0.5 to 10% by weight

As the aqueous component containing the various additives above, various kinds of existing dampening water may be used.

The amount of the aqueous component for supplying on the lithographic printing plate precursor may be varied depending on the kind of the aqueous component and is preferably so as to form the layer having thickness of 0.1 to 5 μm, more preferably so as to form the layer having thickness of 0.5 to 3 μm.

With respect to the temperature of the aqueous component, the aqueous component can be used at an appropriate temperate and the temperature is preferably from 10 to 50° C.

The pH of the aqueous component is preferably from 2.0 to 10.0, more preferably from 3.0 to 9.0, and most preferably from 3.5 to 8.5.

According to the lithographic printing method of the invention, after the imagewise exposure of the lithographic printing plate precursor of the invention with a laser as described above, it is possible to perform a development processing step, followed by conducting printing. However, from the standpoint of the simplification of processing, it is preferred to conduct printing by supplying oily ink and an aqueous component without undergoing the development processing step. The procedure is described in more detail below.

Specifically, for example, a method wherein the lithographic printing plate precursor is exposed with an ina laser and then loaded on a printing machine to conduct printing without undergoing the development processing step or a method wherein the lithographic Printing plate precursor is exposed with an infrared laser on a printing machine and subjected to printing without undergoing the development processing step is exemplified.

After the imagewise exposure of the lithographic printing plate precursor with an infrared laser, when an aqueous component and oily ink are supplied to conduct printing without undergoing the development processing step, for example, a wet development processing step, in the exposed area of the image-recording layer, the image-recording layer cured by the exposure forms the oily ink receptive area having the oleopuilic surface. On the other hand, in the unexposed area, the uncured image-recording layer is removed by dissolution or dispersion with the aqueous component and/or oily ink supplied to reveal a hydrophilic surface in the area.

As a result, the aqueous component adheres on the revealed hydrophilic surface and the oily ink adheres to the exposed area of the image-recording layer, whereby printing is initiated. While either the aqueous component or oily ink may be supplied at first on the surface of lithographic printing plate precursor, it is preferred to supply the oily ink at first in view of preventing the aqueous component from contamination with the unexposed area of the image-recording layer. For the aqueous component and oily ink dampening water and printing ink for conventional lithoghic printing are used respectively.

Thus, the lithographic printing plate precursor is subjeeted to the on-machine development on an offset printing machine and used as it is for printing a large number of sheets.

### EXAMPLES

The present invention will be described in more detail with reference to the following examples, but the invention should not be construed as being limited thereto.

### 1-1. Preparation of Water-Dispersible Polymer Particle (1)

A stirrer, a thermometer, a dropping funnel, a nitrogen inlet tube and a reflux condenser were attached to a 1,000 ml four-neck flask and while carrying out deoxygenation by introduction of nitrogen gas, 425 ml of distilled water was charged to the flask, then as a dispersant, 1.5 g of sodium dodecylbenzenesulfonate was added thereto, followed by heating until the internal temperature reached 70° C. To the mixture, 1.35 g of potassim persulfate was added as an initiator and then 25 g of methyl methacrylate was dropwise added through the dropping fumnel over a period of about 2 hours. After the completion of the dropwise addition, the mixture was continued to react as it was for 3 hours and then the unreacted monomer was removed by steam distillation. After cooling, the reaction mixture was adjusted its pH to 6 with aqueous ammonia and then pure water was added thereto so as to finally have the nonvolatile content of 5% by weight, whereby Water-dispersible polymer particle (1) was obtained. The average particle size of the polymer particle was 0.12 μm.

### 1-2. Preparation of Water-Dispersible Polymer Particle (2)

Water-dispersible polymer particle (2) was obtained in the same manner as in Preparation of Water-dispersible polymer particle (1) except for changing the monomer from the methyl methacrylate to styrene. The average particle size of the polymer particle was 0.15 μm.

### 1-3. Preparation of Water-Dispersible Polymer Particle (3)

Water-dispersible polymer particle (3) was obtained in the same manner as in Prwastron of Water-dispersible polymer particle (1) except for changing the monomer from the methyl methacrylate to acrylamide. The average particle size of the polymer particle was 0.09 μm.

### 1-4. Prepartion of Water-Dispersible Polymer Particle (4)

Water-dispersible polymer particle (4) was obtained in the same manner as in Preparation of Water-disersible polymer particle (1) except for changing the monomer from the methyl methacrylate to Monomer (1) having the structure shown below. The average partile size of the polymer particle was 0.18 μm.

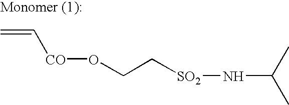

### Eamples 1 to 16 and Comparative Examples 1 to 2

### 2-1. Preparation of Lithograpic Printing Plate Precursors (1) to (12)

### (1) Preparation of Support

An aluminum plate (material: JIS A 1050) having a thickness of 0.3 mm was subjected to a degreasing treatment at 50° C. for 30 seconds using a 100% by weight aqueous sodium aluminate solution in order to remove rolling oil on the surface thereof and then grained the surface thereof using three nylon brushes embedded with bundles of nylon bristle having a diameter of 0.3 mm and an aqueous suspension (specific gravity: 1.1 g/cm³) of pumice having a median size of 25 μm, followed by thorough washing with water. The plate was subeoe to etching by immersing in a 25% by weight aqueous sodium hydroxide solution of 45° C. for 9 seconds, washed with water, then immersed in a 20% by weight aqueous nitric acid solution at 60° C. for 20 seconds, and washed with water. The etching amount of the grained surface was about 3 g/m².

Then, using an alternating current of 60 Hz an electrochemical roughening treatent was continuously carried out on the plate. The electrolyte used was a 1% by weight aqueous nitric acid solution (containing 0.5% by weight of aluminun ion) and the electrolyte temperature was 50° C. Tbe electrochemical roughening treatment was conducted using an alternating current source, which provides a rectangular alternating current having a trapezoidal waveform such that the time TP necessary for the current value to reach the peak from zero was 0.8 msec and the duty ratio was 1:1, and using a carbon electrode as a counter electrode. A ferrite was used as an auxilliary anode. The current density was 30 A/dm² in terms of the peak value of the electric current, and 5% of the electric current flowing from the electric source was divided to the amplify anode. The quantity of electricity in the nitric acid electrolysis was 175 C/dm² in terms of the quantity of electricity when the aluminum plate functioned as an anode. The plate was then washed with water by spraying.

The plate was further subjected to an electrochemical roughening treatment in the same manner as in the nitric acid electrolysis above using as an electrolyte, a 0.5% by weight aqueous hydrochloric acid solution (containing 0.5% by weight of aluminum ion) having temperature of 50° C. and under the condition that the quantity of electricity was 50 C/dm² in terms of the quantity of electricity when the aluminum plate functioned as an anode. The plate was then washed with water by spraying. The plate was subjected to an anodizing treatment using as an electrolyte, a 15% by weight aqueous sulfuric acid solution (containing 0.5% by weight of aluminum ion) at a current density of 15 A/dm² to form a direct current anodized film of 2.5 g/m², washed with water and dried.

Then, in order to ensure the hydrophilicity of the non-image area, the support was subjected to a silicate treatment using a 1.5% by weight aqueous sodium silicate No. 3 solution at 70° C. for 12 seconds. The adhesion amount of Si was 6 mg/m². The support was then washed with water to prepare a substrate. The center line average roughness (Ra) of the substrate was measured using a stylus having a diameter of 2 μm and it was found to be 0.51 μm.

Undercoat solution (1) shown below was applied on the substrate described above so as to have a dry coating amount of 8 mg/m² to prepare a support for using in the experiments described below.

| Undercoat solution (1) | | |
|---|---|---|
| Undercoat compound (1) shown below | 0.017 | g |
| Methanol | 9.00 | g |
| Distilled water | 1.00 | g |

Undercoat compound (1):

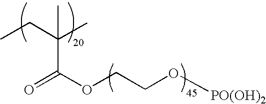

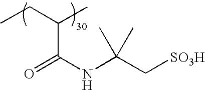

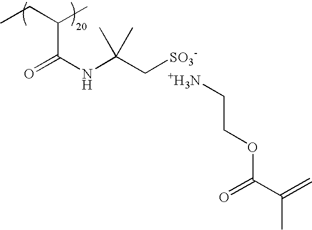

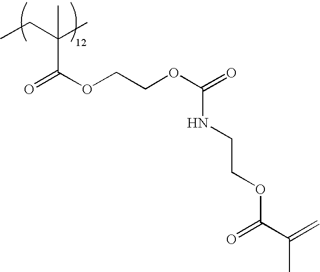

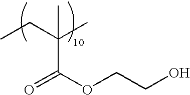

### (2) Formation of Image-Recording Layer

Coating solution (1) for image-recording layer having the composition shown below was applied on the above-descibed support having the undercoat layer by a bar and dried in an oven at 100° C. for 60 seconds to form an image-recording layer having a dry coating amount of 1.0 g/m².

Coating solution (1) for image-recording layer was prepared by mixing Photosensitive solution (1) shown below with Microgel solution (1) shown below just before the coating, followed by stirring.

| Photosensitive solution (1) | | |
|---|---|---|
| Binder polymer (1) shown below | 0.162 | g |
| Infrared absorbing agent (1) shown below | 0.030 | g |
| Polymerization initiator (1) shown below | 0.162 | g |
| Polymerizable compound (Aronics M-315, produced by Toagosei Co., Ltd.) | 0.385 | g |
| Fluorine-based surfactant (1) shown below | 0.044 | g |
| Methyl ethyl ketone | 1.091 | g |
| 1-Methoxy-2-propanol | 8.609 | g |
| Microgel solution (1) | | |
| Microgel (1) prepared as shown below | 2.640 | g |
| Distilled water | 2.425 | g |

Binder polymer (1):

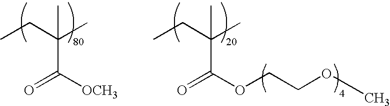

weight average molecular weight = 80,000
Infrared absorbing agent (1):

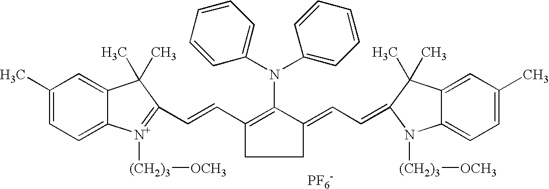

Polymerization initiator (1):

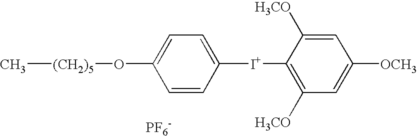

Fluorine-based surfactant (1):

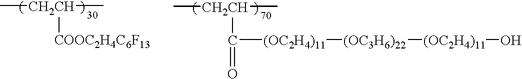

### Preparation of Microgel (1)

An oil phase component was prapared by dissolving 10 g of adduct of trimethylol propane and xylene diisocyanate (Takenate D-110N, produced by Mitsui Takeda Chemical Co., Ltd.), 3.15 g of pentaerythritol triacrylate (SR444, produced by Nippon Kayaku Co., Ltd.) and 0.1 g of Pionin A-41C (produced by Takemoto Oil and Fat Co., Ltc) in 17 g of ethyl acetate. As an aqueous phase component, 40 g of an aqueous 4% by weight solution of PVA-205 was prepared. The oil phase component and the aqueous phase component were mixed and emulsified using a homogenizer at 12,000 rpm for 10 minutes. The resulting emulsion was added to 25 g of distilled water and stirred at a room temperature for 30 minutes and then at 50° C. for 3 hours. The thus obtained microgel liquid was diluted using distilled water so as to have the solid concentration of 15% by weight. The average particle size of the microgel was 0.2 μm.

### (3) Formation of Overcoat Layer

Coating solution (1) for overcoat layer having the composition shown below was applied on the image recording layer by a bar and dried in an oven at 125° C. for 75 seconds to form an overcoat layer having a dry coating amount shown in Table 1 below, thereby preparing Lithographic printing plate precursors (1) to (12), respectively.

Coating solution (1) for overcoat layer

| | |
|---|---|
| Water-dispersible polymer particle shown in Table 1 (adjusted | 2.0 g |
| solid content to 5% by weight) | |
| Nonionic surfactant (Emalex 710, produced by Nihon Emulsion | 0.01 g |
| Co., Ltd.) | |
| Ion-exchanged water | 3.0 g |

### 2-2. Preparation of Lithographic Printing Plate Precursors (13) to (16)

Lithographic printing plate precursors (13) to (16) were prepared in the same manner as in the preparation of lithographic printing plate precursors (1), (3), (6) and (8) except for changing Coating solution (1) for image-recording layer in the preparation of Lithographic printing plate precursor (1) to Coating solution (2) for image-recording layer shown below, respectvely.

Coating solution (2) for image-recording layer

| | | |
|---|---|---|
| Binder polymer (1) shown above | 0.50 | g |
| Infrared absorbing agent (2) shown below | 0.05 | g |
| Polymerization initiator (1) shown above | 0.20 | g |
| Polymerizable compound (Aronics M-315, produced by | 1.00 | g |
| Toagosei Co., Ltd.) | | |
| Fluorine-based surfactant (1) shown above | 0.10 | g |
| Methyl ethyl ketone | 18.0 | g |

Infrared absorbing agent (2):

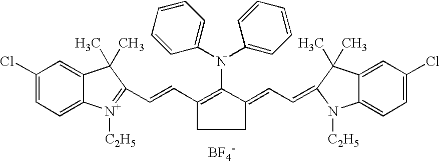

### 2-3. Preparion of Lithographic Printing Plate Precursor (17)

Lithographic printing plate precursor (17) was prepared in the same manner as in the preparation of Lithographic printing plate precursor (1) except for eliminatng the overcoat layer in the preparation of Lithographic printing plate precursor (1).

2-4. Preparation of Lithographic Printing Plate Precursor (18) Lithographic printing plate precursor (18) was prepared in the same manmer as in the preparation of Lithographic printing plate precursor (1) except for changing Coating solution (1) for overcoat layer in the preparation of Lithographic printing plate precursor (1) to Coating solution (2) for overcoat layer shown below.

Coating solution (2) for overcoat layer

| | |
|---|---|
| Polyvinyl alcohol (Poval PVA-105, saponification degree: 98 to | 0.895 g |
| 99% by mole, polymerization degree: 500, produced by Kuraray | |
| Co., Ltd.) | |
| Polyvinyl pyrrolidone (K30, weight average molecular weight: | 0.035 g |
| 400,000, produced by Wako Pure Chemical Industries, Ltd.) | |
| Polyvinyl pyrrolidone copolymer (Luviskol VA64W, weight | 0.048 g |
| average molecular weight: 34,000; vinyl pyrrolidone/vinyl | |
| acetate = 60/40 in molar ratio, produced by BASF Japan | |
| Ltd., 50% by weight aqueous solution) | |
| Nonionic surfactant (Emalex 710, produced by Nihon Emulsion | 0.02 g |
| Co., Ltd.) | |
| Ion-exchanged water | 15.20 g |

### 3. Evaluation of Lithographic Printing Plate Precursor

### 3-1. Evaluation of Printing Durability

Each of Lithographic pinting plate precursors (1) to (18) thus-obtained was exposed by Luxel Platesetter T-6000III equipped with an infrared semiconductor laser, produced by Fuji Photo Film Co., Ltd. under the conditions of a rotational number of outer surface drum of 1,000 rpm, a laser output of 70% and a resolution of 2,400 dpi. The exposed image contained halftone dots of a 20 μm-dot FM sorter.

The exposed lithographic printing plate precursor was loaded without performing development processing on a plate cylinder of a printing machine (Lithrone 26, produced by Komori Corp.). Using dampening water (Ecolity-2, produced by Fuji Photo Film Co., Ltd/water=2/98 (volume ratio)) and Fusion (N) Black Ink produced by Dainippon Ink and Chemicals, Inc.), the ink and dampening water were supplied to conduct printing of 100 sheets at a printing speed of 10,000 sheets per hour.

The amount of the ink supplied was controlled so that the ink density (reflection density) of solid portion of the printing paper mired by a Gretag densitometer became 1.9, then the amount of the dampening water supplied was controlled so that the non-image area of the printing paper was not stained with the ink, and the printing was continued. As the increase in a number of printing, the image-recording layer was gradually abraded to cause decrease in the ink density of solid portion on the printing paper. A number of printing papers wherein the ink density of solid portion decreased by 0.2 compared with that of the initaton of printing was destined to evaluate the printing durability. The results are shown in Table 1.

### 3-2. Evaluation of Ink-Receptive Property

During the printing for the evaluation of the printing durability, 10,000th printing paper was sampled and the ink density of 20% halftone dot of FM scree was measured by a Gretag densitometer. Based on the value measured, the evaluation of ink-receptive property was conducted according to the criteria described below. The results are shown in Table 1.

A: Ink density of 1.8 to 1.9 (the ink density do not decrease at all and the ink-receptive property is excellent.)

B: Ink density of 1.3 to 1.7 (the ink density somewhat decreses but the ink-receptive property is still within the acceptable level.)

C: Ink density of 1.0 to 1.4 (the ink density definitely decreases and the ink-receptive property is at the unacceptable level.)

D: Ink density of 0.9 or less (the ink density severely decreases and the ink-receptive property is very bad.)

As is apparent from the results shown in Table 1, the lithographic printing plate having the improved printing durability and the excellent ink-receptive property can be provided by the lithographic printing plate precursor and the method of for preparation of the lithographic printing plate precursor according to the invention.

TABLE 1

| | | | Overcoat Layer | | | | |
|---|---|---|---|---|---|---|---|
| | Lithographic | Coating Solution | | | Coating | Printing | |
| | Printing Plate | for Image- | Coating | Water-dispersible Polymer | Amount | Durability | Ink-receptive |
| | Precursor | recording Layer | Solution | Particle | (g/m²) | (×10⁴ sheets) | Property |
| Example 1 | (1) | (1) | (1) | (1) | 0.15 | 8.5 | A |
| Example 2 | (2) | (1) | (1) | (2) | 0.15 | 9.0 | A |
| Example 3 | (3) | (1) | (1) | (3) | 0.15 | 11.0 | A |
| Example 4 | (4) | (1) | (1) | (3) | 0.45 | 12.0 | A |
| Example 5 | (5) | (1) | (1) | (4) | 0.15 | 10.5 | A |
| Example 6 | (6) | (1) | (1) | (5) | 0.15 | 9.0 | A |
| Example 7 | (7) | (1) | (1) | (6) | 0.08 | 8.5 | A |
| Example 8 | (8) | (1) | (1) | (6) | 0.15 | 10.0 | A |
| Example 9 | (9) | (1) | (1) | (7) | 0.15 | 8.0 | A |
| Example 10 | (10) | (1) | (1) | (8) | 0.15 | 9.0 | A |
| Example 11 | (11) | (1) | (1) | (9) | 0.15 | 12.0 | A |
| Example 12 | (12) | (1) | (1) | (10) | 0.15 | 11.0 | A |
| Example 13 | (13) | (2) | (1) | (1) | 0.15 | 8.0 | A |
| Example 14 | (14) | (2) | (1) | (3) | 0.15 | 10.0 | A |
| Example 15 | (15) | (2) | (1) | (5) | 0.15 | 8.0 | A |
| Example 16 | (16) | (2) | (1) | (6) | 0.15 | 9.0 | A |
| Comparative | (17) | (1) | No overcoat layer | | | 1.0 | A |
| Example 1 | | | | | | | |
| Comparative | (18) | (1) | (2) | None | 0.45 | 2.0 | C |
| Example 2 | | | | | | | |

Water-dispersible polymer particle (5): Chemipearl S-200, produced by Mitsui Chemicals Inc., polyolefin latex, average particle size: 0.6 μm or less)
Water-dispersible polymer particle (6): Takelac W-605, produced by Mitsui Takeda Chemicals, Inc., aqueous polyurethane resin average particle size: 0.08 μm)
Water-dispersible polymer particle (7): Superflex 420, produced by Dai-ichi Kogyo Seiyaku Co., Ltd., aqueous polyurethane dispersion, average particle size: 0.008 μm)
Water-dispersible polymer particle (8): Superflex E-2000, produced by Dai-ichi Kogyo Seiyaku Co., Ltd., aqueous polyurethane dispersion, average particle size; 1.6 μm)
Water-dispersible polymer particle (9): Nipol LX531, produced by Zeon Corp., NBR latex, average particle size: 0.30 μm)
Water-dispersible polymer particle (10): AE322, produced by JSR Corp., acrylic emulsion, soap-free, average particle size: 0.16 μm)

This application is based on Japanese Patent application JP 2006-263212, filed Sep. 27, 2006, the entire content of which is hereby incorporated by reference, the same as if fully set forth herein.

Although the invention has been described above in relation to preferred embodiments and modifications thereof, it will be understood by those skilled in the art that other variations and modifications can be effected in these preferred embodiments without departing from the scope and spirit of the invention.

What is claimed is:

1. A lithographic printing plate precursor comprising: a support; an image-recording layer capable of being removed with water or an aqueous component; and an overcoat layer, in this order, wherein the overcoat layer is formed by drying a water-dispersible polymer particle.

2. A lithographic printing plate precursor comprising: a support; an image-recording layer which is capable of being removed with at least one of printing ink and dampening water and contains (A) an iced absorbing agent, (B) a polymerization initiator and (C) a polymerizable compound; and an overcoat layer, in this order, wherein the overcoat layer is formed by dying a water-dispersible polymer particle.

3. The lithographic printing plate precursor as claimed in claim 1, wherein an average particle size of the water-dispersible polymer particle is from 0.01 to 1 μm.

4. The lithogrmhic printing plate precursor as claimed in claim 2, wherein an average particle size of the water-dispersible polymer particle is from 0.01 to 1 μm.

5. The lithographic printing plate precursor as claimed in claim 1, wherein a polymer included in the water-disible polymer particle has an amido group or a sulfonylamido group in a side chain of the polymer.

6. The lithographic printing plate precursor as claimed in claim 2, wherein a polymer included in the water-dispersible polymer particle has an amido group or a sulfonylamido group in a side chain of the polymer.

7. The lithographic printing plate precursor as claimed in claim 2, wherein the image-recording layer further contains (D) a polymer particle having a polymerizable reactive group.

8. The lithographic printing plate precursor as claimed in claim 1, which further comprises a undercoat layer comprising a compound having a polymerizable reactive group between the support and the image-recording layer.

9. The lithographic printing plate precursor as claimed in claim 2, which further comprises an undercoat layer comprising a compound having a polymerizable reactive group betwee the support and the image-rcording layer.

10. A method for preparing a lithographic printing plate precursor comprising a support, an image-recording layer which is capable of being removed with at least one of printing ink and dampening water and contains (A) an infrared absorbing agent, (B) a polymerization initiator and (C) a polyrerizable compound, and an overcoat layer, in this order, wherein the method comprises: forming the overcoat layer by drying a water-dispersible polymer particle.
